(19) United States
(12) Patent Application Publication
(10) Pub. No.: US 2012/0093613 A1
(43) Pub. Date: Apr. 19, 2012

(54) BOOKBINDING APPARATUS AND BOOKBINDING SYSTEM

(75) Inventor: Masato HATTORI, Tokyo (JP)

(73) Assignee: KONICA MINOLTA BUSINESS TECHNOLOGIES, INC., Tokyo (JP)

(21) Appl. No.: 13/271,496

(22) Filed: Oct. 12, 2011

(30) Foreign Application Priority Data
Oct. 15, 2010 (JP) JP2010-232298

(51) Int. Cl. B42C 9/00

(52) U.S. Cl. 412/20

(57) ABSTRACT

A bookbinding apparatus including: a stacking section for stacking sheets to form a bundle of sheets; a sheet-conveyance shifting section for conveying a sheet, or a cover sheet to become a cover of a booklet to a predetermined position; a melt tank for storing a hot-melt adhesive, and a bookbinding control section configured to execute a bookbinding mode in which a booklet is formed by coating adhesive inside the melt tank onto an edge surface of a bundle of sheets and adhering the cover sheet to the edge surface, onto which the adhesive has been coated, of the bundle of sheets, and an adhesive discharging mode in which the adhesive inside the melt tank is discharged outside the melt tank.

This application is based on Japanese Patent Application No. 2010-232298 filed on Oct. 15, 2010 with the Japan Patent Office, the entire content of which is hereby incorporated by reference.

### TECHNICAL FIELD

The present invention relates to a bookbinding apparatus in which a bundle of sheets is bound together with a cover sheet by coating an adhesive having been melted with heating to an edge surface of the bundle of sheets, and a bookbinding system composed of such bookbinding apparatus and an image forming apparatus connected to the bookbinding apparatus.

### BACKGROUND OF THE INVENTION

Such bookbinding apparatus is often used as a bookbinding system in which the bookbinding apparatus is connected to an image forming apparatus to form an image on a sheet, and in conjunction with an operation of the image forming apparatus, the sheets, ejected from the image forming apparatus, are bound. Also, a bookbinding apparatus which performs a so-called case binding process is known in which a bundle of sheets to be bound is formed, and a sheet to be used as a cover sheet is bound together with the bundle of sheets by coating an adhesive to a spine portion of the edge surface of the bundle of sheets, to form a booklet in a form in which the bundle of sheets is wrapped by the cover sheet in a U-shape.

As an adhesive to be used in the case binding process, a hot-melt adhesive (hereinafter referred simply to as adhesive) is used. The adhesive is stored in an adhesive storage section, such as a melt tank as an example, and in prior to the execution of the bookbinding processing, the adhesive is heated by a heating means to a predetermined temperature and melted. Then, the adhesive is applied to the spine portion of the bundle of sheets in the molten state, and then the adhesive releases the heat and cools down in the state in which it bonds the bundle of sheets and cover sheet together. The hot-melt adhesive is solidified after being cooled, and the bundle of sheets and the cover sheet are adhered to each other, and the bundle of sheets becomes a bound booklet.

As such case binding process is executed, the adhesive in the melt tank is consumed and reduced. In order to carry out the case binding process, it is necessary to maintain the amount of the adhesive inside the melt tank within a predetermined range, and normally, new adhesive is replenished when the amount of the adhesive inside the melt tank becomes less than or equal to the predetermined range, and the amount of the adhesive inside the melt tank is maintained within the predetermined range.

In the meantime, an adhesive of a hot-melt type deteriorates when it is heated for a prolonged period of time. The deterioration includes a change of color, staining, generation of an odor, production of solids, and the like, and becomes a cause to degrade the bookbinding quality, or to exert an adverse influence on installed environment of the bookbinding apparatus.

Therefore, a technique has been suggested, in which, when a standby state, in which an application operation is not performed, continues for a predetermined period of time, heating condition of the heating means, which heats the adhesive inside an adhesive storage section (melt tank), is changed to maintain the temperature of the adhesive inside the adhesive storage section at a keep-warm temperature, which is lower than the bookbinding performing temperature, so that the deterioration of the adhesive is inhibited (refer to Japanese Patent Application Publication No. 2005-23826). The present invention has been achieved in consideration of the above problems.

### SUMMARY OF THE INVENTION

[1] To achieve at least one of the objects of the present invention, a bookbinding apparatus reflecting one aspect of the present invention may include, but is not limited to: a stacking section for stacking sheets to form a bundle of sheets; a sheet-conveyance shifting section for conveying a sheet or cover sheet to be a cover of a booklet to a predetermined position; a melt tank for storing a hot-melt adhesive, and a bookbinding control section configured to execute a bookbinding mode in which a booklet is formed by coating an adhesive, inside said melt tank, to an edge surface of a bundle of sheets and adhering the cover sheet to the edge surface, onto which the adhesive has been coated, of the bundle of sheets, and an adhesive discharging mode in which the adhesive inside said melt tank is discharged outside said melt tank.
[2] A bookbinding system, reflecting an aspect of the present invention, may include, but is not limited to, an image forming apparatus for forming an image on a sheet, and the bookbinding apparatus for receiving a sheet to form a booklet described in any one of Claims 1 through 9.

### BRIEF DESCRIPTION OF THE DRAWINGS

The preferred embodiments of the present invention are shown by way of example, and not limitation, in the accompanying figures, in which:

FIG. 1 is a diagram schematically illustrating the entire of a bookbinding system according to a preferred embodiment of the present invention.

FIG. 2 is a diagram illustrating a frontal cross-sectional view of bookbinding apparatus B.

FIGS. 3a, 3b, and 3c are each an explanatory diagram illustrating a step for coating an adhesive onto a bundle of sheet S1.

FIGS. 4a, 4b, 4c, 4d, and 4e are each an explanatory diagram illustrating adhesive coating section 60.

FIG. 5 is an explanatory diagram illustrating lid member 65.

FIGS. 6a and 6b are each an explanatory diagram illustrating an operation of lid member 65 in line with a turning operation of melt tank 61.

FIGS. 7a and 7b are each an explanatory diagram illustrating shifting of adhesive coating section 60.

FIGS. 8a, 8b, and 8c are each an explanatory diagram illustrating a step for binding a cover sheet onto a bundle of sheets.

FIG. 9 is a diagram illustrating a top view of cover folding section 901.

FIGS. 10a, 10b, and 10c are each an explanatory diagram illustrating a process for a cover sheet after binding.

FIG. 11 is a block diagram illustrating a control system for controlling a bookbinding system according to a preferred embodiment.

FIGS. 12a, 12b, 12c, 12d, and 12e are each a diagram illustrating an example of a screen displayed on mode switching input section 38.

FIG. 13 is an explanatory flow chart illustrating control operation of bookbinding apparatus B in a bookbinding system according to a preferred embodiment of the present invention.

FIG. 14 is a flow chart illustrating a first half of details of step S5 in FIG. 13 expanded into steps S501 to S505.

FIG. 15 is a flow chart illustrating a last half of details of step S5 in FIG. 13 expanded into steps S506 to S516.

FIGS. 16a and 16b are each an explanatory diagram illustrating a positional relationship between melt tank 61 and a cover sheet when bookbinding apparatus B operates in an adhesive discharging mode and discharges an adhesive.

FIG. 17 is an explanatory flow chart illustrating an operation of a bookbinding apparatus according to a second preferred embodiment of the present invention.

FIGS. 18a, 18b, and 18c are each an explanatory diagram illustrating a positional relationship between melt tank 61 and a cover sheet when a bookbinding apparatus, according to the second preferred embodiment, operates in an adhesive discharging mode and discharges an adhesive.

FIG. 19 is an explanatory flow chart illustrating a part of a flow chart of an operation of a modification of the second preferred embodiment according to the present invention.

FIG. 20 is an explanatory flow chart illustrating the remainder of the flow chart of the operation of a modification of the second preferred embodiment according to the present invention.

FIGS. 21a, 21b, and 21c are each an explanatory diagram illustrating a positional relationship between melt tank 61 and a cover sheet when the modification of the second preferred embodiment operates in an adhesive discharging mode and discharges an adhesive.

### DETAILED DESCRIPTION OF THE PREFERRED EMBODIMENTS

Hereinafter, preferred embodiments of the present invention will be described in detail with reference to the accompanying drawings, without the present invention being limited to the embodiment.

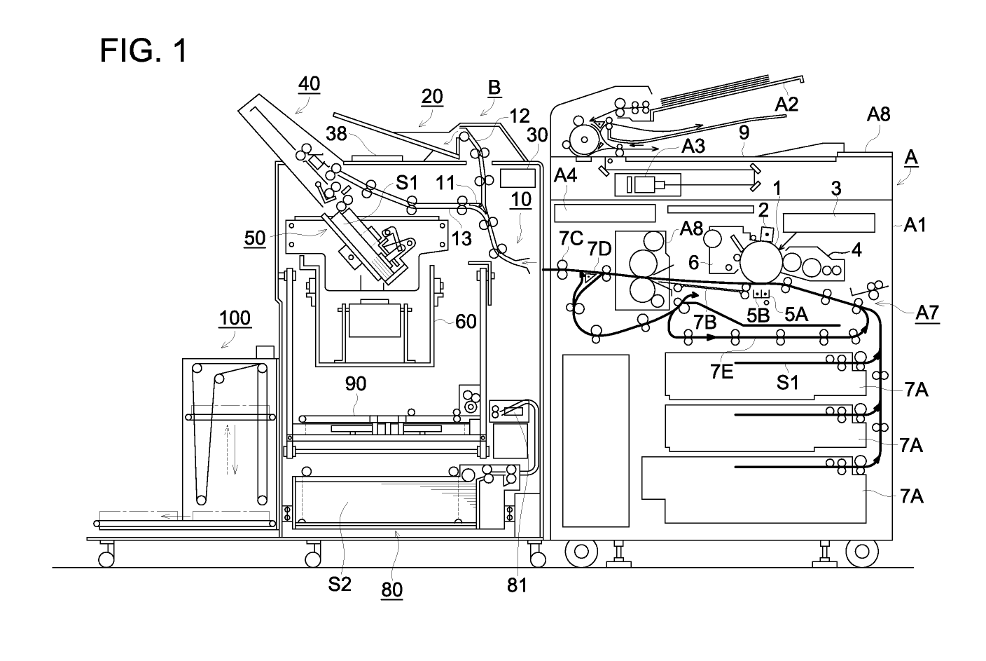

FIG. 1 is a diagram schematically illustrating a bookbinding system composed of an image forming apparatus and a bookbinding system according to a preferred embodiment of the present invention, which are connected together. The bookbinding system is composed of image forming apparatus A and bookbinding apparatus B.

Image forming apparatus A forms an image on a sheet, via an electro-photographic process, and ejects the sheet. Image forming apparatus A includes, but is not limited to, image forming section A1, automatic document feeder A2, image reading section A3, control section A4, fixing section A6, sheet conveyance section A7, and operation display section A8.

Control section A4 is configured to control operations of each part of image forming apparatus A, based on job conditions input by a user, via operation display section A8, and carries out an image formation based on the job conditions having been input.

Automatic document feeder A2 conveys an original document one by one to a reading position. Image reading section A3 reads the image of the original document, having been conveyed by automatic document feeder A2, or an original document placed on platen 9, and obtains image information.

In image forming section A1, disposed around photoreceptor 1, in the shape of a drum, are charging device 2, exposure device 3, developing device 4, transfer device 5A, separation device 5B, and cleaning device 6, and via those electro-photographic process sections, charging, exposure, development, and transfer are carried out, and a toner image is formed onto photoreceptor 1 based on the image information having been obtained by image reading section A3. This toner image is transferred onto sheet S1 which has been conveyed via sheet conveyance section A7.

Sheet S1 is stored in paper feeding trays 7A, and sheet 51, which meets the job conditions input via operation display section A8, is fed one by one from sheet conveyance section A7 under the control of control section A4, and via transfer device 5A, the toner image on photoreceptor 1 is transferred onto sheet S1.

The toner image, having been transferred onto sheet S1, is subjected to a fixing process by being passed through fixing section A6. The fix-processed sheet S1 is conveyed to bookbinding apparatus B via switching gate 7D, through sheet ejection roller 7C, or is switched and guided, via switching gate 7D, into sheet re-feeding path 7E.

If a job condition is for “face-up sheet ejection in single-sided printing”, and if a job condition is for “double-sided printing and sheet S1 has been fix-processed for both the front and back surfaces thereof”, the fix-processed sheet S1 is guided, via switching gate 7D, to the left in the figure, and conveyed into bookbinding apparatus B via sheet ejection roller 7C.

On the other hand, if a job condition is for “face-down sheet ejection in single-sided printing”, and if a job condition is for “double-sided printing and sheet S1 has been fix-processed for one surface thereof”, the fix-processed sheet S1 is guided, via switching gate 7D, downward in the figure.

In a case of face-down sheet ejection, sheet S1 is guided and conveyed downward in the figure, and then the sheet is switched back upward in the figure, and conveyed into bookbinding apparatus B via sheet ejection roller 7C.

In a case in which image formation is carried out on both surfaces of the sheet, sheet S1, on one surface of which an image has been transferred and fixed, is guided downward in the figure, and through sheet re-feeding path 7E after being reversed inside out by a switchback, sheet S1 is re-fed into the transfer section, where transfer device 5A is disposed, then an image is transferred onto the back surface of sheet S1. Sheet S1, with the image having been transferred onto the back surface thereof, is fix-processed, and conveyed into bookbinding apparatus B via sheet ejection roller 7C.

Bookbinding apparatus B is a bookbinding apparatus which performs a case binding process in which the bookbinding apparatus forms a bundle of sheets by bundling a plurality of sheets having been conveyed from image forming apparatus A, and coats an adhesive on the spine of an edge surface of the bundle of sheets, and also, adheres a cover to the spine of the bundle of sheets to form a booklet which is composed of a bundle of sheets and a cover.

Bookbinding apparatus B is capable of operating in two operation modes, a bookbinding mode and an adhesive discharging mode. When operating in the bookbinding mode, bookbinding apparatus B performs the case binding process with respect to the sheets ejected from image forming apparatus A in conjunction with image forming operations of image forming apparatus A, or ejects the sheets outside the bookbinding apparatus without performing the case binding process. When operating in the adhesive discharging mode, the bookbinding apparatus is capable of discharging safely adhesive having been stored in melt tank 61, which will be described later. The operation of this adhesive discharging mode will be described in detail later.

Bookbinding apparatus B is capable of operating in the bookbinding mode under normal conditions, and in the adhesive discharging mode via the user operation.

Bookbinding apparatus B may include, but is not limited to, sheet reversing section 40, stacking section 50, adhesive coating section 60, cover sheet-conveyance shifting section 90, and further, sheet conveyance section 10, sheet-ejection tray 20, bookbinding control section 30, cover sheet storage section 80, mode switching input section 38, and booklet ejecting section 100. It should be noted that cover sheet-conveyance shifting section 90 is explained in the preferred embodiments as an example of a sheet-conveyance shifting section.

Bookbinding apparatus B is configured to operate in the bookbinding mode under normal conditions, and operates in the adhesive discharging mode only when an input operation is carried out, via mode switching input section 38, for operating in the adhesive discharging mode by an operator or a person in charge of maintenance service.

Bookbinding control section 30 is configured, when operating in the bookbinding mode, to control operations of each part of bookbinding apparatus B based on job conditions input by a user via operation display section A8 of image forming apparatus of A, in association with control section A4 of image forming apparatus A, and performs the processing of sheet S1 received from image forming apparatus A.

An operation in which bookbinding apparatus B operates in the bookbinding mode will be now described. It should be noted that, in the following explanations, a sheet on which an image is formed in image forming apparatus A and to be conveyed to bookbinding apparatus B is referred to as sheet S1, a cover sheet is referred to as cover sheet S2, and a booklet which has been formed by binding sheet S1 to cover sheet S2 is referred to as booklet S3.

Sheet S1 received from image forming apparatus A is conveyed via sheet conveyance section 10. Then, via switching gate 11 provided in sheet conveyance section 10, sheet S1 is either ejected onto sheet ejection tray 20 via ejection path 12, or conveyed to sheet reversing section 40.

If it is a case (to be determined by job conditions input by a user via operation display section A8) in which the received sheet S1 is not subjected to the case binding, sheet S1 is ejected onto sheet ejection tray 20 via ejection path 12.

If it is a case in which sheet S1 is a subject for the warp bookbinding, received sheet S1 is conveyed to sheet reversing section 40 via conveyance path 13.

Sheet S1, having been conveyed to sheet reversing section 40, is conveyed to stacking section 50, after having been switched back at sheet reversing section 40. In stacking section 50, a plurality of sheets S1, having been conveyed, are stacked and a bundle of sheets is formed. The number of sheets S1, the number which is determined by job conditions to form a booklet, is stacked in stacking section 50, and when a bundle of sheets S1, to become a booklet, is formed, the bundle of sheets S1 is rotated and maintained in the nearly vertical state.

To the lower side edge surface (spine portion) of the bundle of sheets S1, having been maintained nearly vertical, an adhesive is coated via adhesive coating section 60.

Cover sheet S2, having been conveyed to a position corresponding to stacking section 50 via cover sheet-conveyance shifting section 90, is pressed to the edge surface of the bundle of sheets S1, and the bundle of sheets S1 and cover sheet S2 are adhered, and cover sheet S2 is folded in a U-shape.

Booklet S3, having been formed by adhering cover sheet S2 to the bundle of sheets S1, is ejected to booklet ejecting section 100.

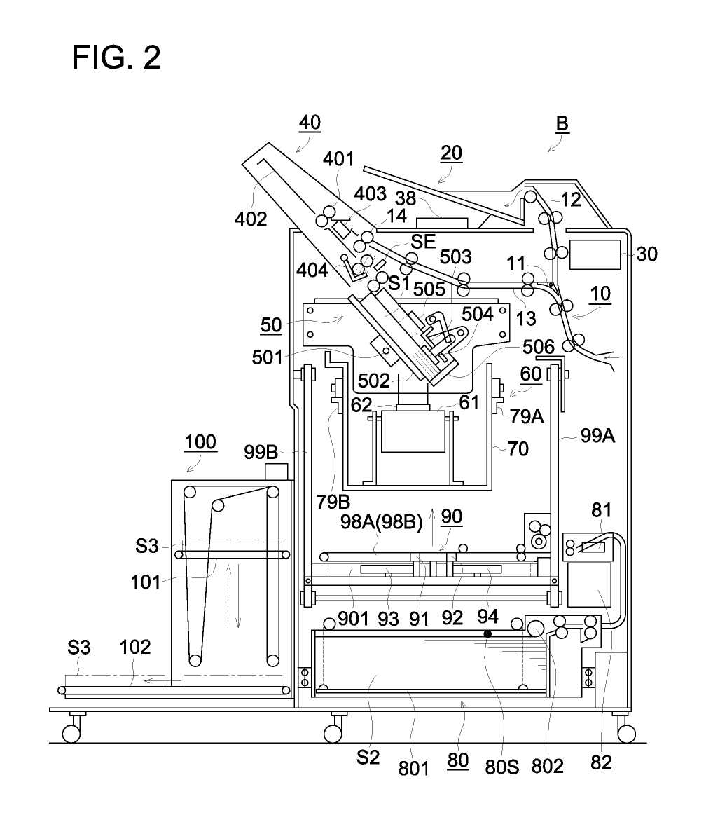

FIG. 2 is a diagram illustrating a frontal cross-sectional view of bookbinding apparatus B. Bookbinding apparatus B includes sheet conveyance section 10, bookbinding control section 30, sheet reversing section 40, stacking section 50, adhesive coating section 60, cover sheet storage section 80, cover sheet-conveyance shifting section 90, and mode switching input section 38.

Adhesive coating section 60 includes melt tank 61, which stores melted adhesive and is equipped with coating roller 62, and movable casing 70 which is equipped with melt tank 61 and moves inside bookbinding apparatus B.

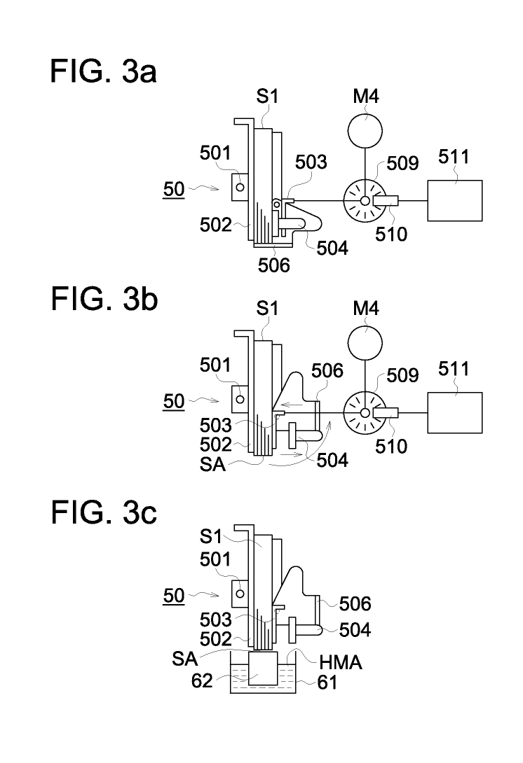

Movable casing 70 is disposed movably, along with guide plates 79A and 79B, in the direction perpendicular to the paper plain in FIG. 3, in bookbinding apparatus B.

When movable casing 70 moves, melt tank 61, mounted in movable casing 70, is shifted to the direction perpendicular to the paper plain in FIG. 3, and coating roller 62, which carries the melted adhesive inside melt tank 61, comes into contact with lower edge surface SA of the bundle of sheets S1, and coats adhesive onto lower edge surface SA of the bundle of sheets S1.

Then, under the control of bookbinding control section 30, the bookbinding apparatus coats the adhesive to the edge surface of the bundle of sheets S1 via adhesive coating section 60, binds cover sheet S2 to the bundle of sheets S1 having been coated by the adhesive, and forms a booklet by folding cover sheet S2 into a U-shape.

Cover sheet S2 is stored in cover sheet storing tray 801 of cover sheet storage section 80, and is fed via feed-out roller 802. Then, the rear end side of the sheet, in the conveyance direction, is cut, via cutter 81 serving as a cutting section, to an appropriate length. Cover sheet S2, having been cut, is conveyed, via horizontal belts 98A and 98B of cover sheet-conveyance shifting section 90, to a position corresponding to the bundle of sheets S1 onto which the adhesive has been coated. Then, cover sheet S2 is pressed to the bundle of sheets S1 via cover sheet-conveyance shifting section 90, and further, cover sheet S2 is folded in a U-shape to form a booklet. Here, symbol 80S is a sheet sensor to detect existence or non-existence of cover sheet S2 inside cover sheet storage section 80.

Mode switching input section 38 is an input section for operating bookbinding apparatus B, which operates in the bookbinding mode under normal conditions, in the adhesive discharging mode, and vice versa. Mode switching input section 38 displays not only the screens which display the modes in which bookbinding apparatus operates, but also the screens by which judgment results of an operator or a person in charge of maintenance can be input via mode switching input section 38. The screens, to be displayed, will be described later.

When bookbinding apparatus B operates in the bookbinding mode, sheet S1, having been conveyed through conveyance path 13, is conveyed via sheet ejecting roller 14, and is further conveyed upward along inclined reversing guide 402, via conveyance roller 401, and then, by reversing the rotation of conveyance roller 401, sheet S1 is conveyed downward. Symbol 403 is an aligning member to align sheet S1 on reversing guide 402, symbol 404 is a stopper to be used to temporarily stack a plurality of sheets S1 in reversing section 402, and can be configured into the position illustrated by a solid line or the position illustrated by a dotted line. At the position illustrated by a solid line, sheet S1 is not stacked on reversing guide 402, and at the position illustrated by a dotted line, sheet S1 is temporarily stacked on reversing guide 402. Aligning member 403 operates, in the case when the sheet is stacked in reversing guide 402, to align the sheet in a width direction of conveyance. Reversing guide 402 and stopper 404 constitute a buffer stacking section to temporarily stack sheets S1 at a stage prior to stacking sheets S1 in stacking section 50.

When stopper 404 is at the position illustrated by a solid line, sheets S1 slide down onto stacking section 50 and are stacked. Stacking section 50 includes supporting plate 502 and receiving plate 506, and sheet S1, having descended from sheet reversing section 40, is supported in an inclined state by supporting plate 502 and receiving plate 506.

Sheets S1, having been ejected in series from image forming apparatus A, are stacked in stacking section 50, and a bundle of sheets S1 is formed. The number of sheets S1 to form a bundle is the number of sheets to become a booklet, and is determined by job conditions. Symbol 504 is a holding member to hold sheets S1 having been stacked, and symbol 505 is aligning plates to align side edges of the sheets.

A bundle of the number of sheets S1 to become a booklet is stacked, and when a bundle of the sheets is formed, stacking section 50 rotates about axis 501 serving as rotational axis, and positions the bundle of sheets S1 from an inclined sate to a vertical state. Onto the bundle of sheets S1 in a vertical state, coating of adhesive is carried out.

FIGS. 3a, 3b, and 3c each is an explanatory diagram illustrating a step for coating adhesive onto a bundle of sheets S1. FIG. 3a is a diagram illustrating a state in which sheet S1 is maintained in a vertical state. At that time, the bundle of sheets S1 is sandwiched and held by supporting plate 502 and holding member 504, and also, the bottom part of the bundle is in contact with receiving plate 506, thus the bundle does not slide downward. Here, holding plate 503 is at a position away from the bundle of sheets S1, in other words, supporting member 503 is in a hold-releasing position in which the bundle of sheets S1 is not held.

FIG. 3b is a diagram illustrating a state in which holding plate 503 is shifted by being driven by holding plate drive motor M4, and presses on the bundle of sheets S1, and is shifted together with supporting plate 502 to a sheet holding position to hold the bundle of sheets S1.

At the time of shifting of holding plate 503, when an abrupt increase of driving torque of holding plate drive motor M4 is detected in a process in which holding plate 503 comes into contact with the bundle of sheets S1 and presses it, holding plate drive motor M4 is stopped, and the bundle of sheets S1 is securely held by supporting plate 502 and holding plate 503. Also, the stop position of this holding plate 503 is detected by encoder 509, and as information on the thickness of the bundle of sheets S1, it is memorized in position detecting section 511.

At the stage in which the bundle of sheets S1 is held, holding member 504 and receiving plate 506 are shifted by a driving mechanism (not illustrated in the figure). By the shifting of receiving plate 506, lower edge surface SA (the lower surface in FIG. 3b) of the bundle of sheets S1 is exposed. In this state, the bundle of sheets S1 is being held by supporting plate 502, and by holding plate 503 which has been shifted to the sheet holding position, and therefore, the bundle does not slide downward.

When lower edge surface SA is released, adhesive coating section 60 is shifted from a home position, and melt tank 61 mounted in movable casing 70, which is not illustrated in the figure, is shifted in the direction perpendicular to the paper plain in FIG. 3c. Along with the shifting of melt tank 61, coating roller 62, which is provided to melt tank 61, comes into contact, while rotating, with lower edge surface SA of the bundle of sheets S1, having been exposed.

Symbol HMA, illustrated in the figure, is adhesive stored in melt tank 61. Adhesive HMA is a hot-melt adhesive which is molten when it reaches a high temperature and is solidified when it is cooled, and is molten by being heated by a heater which is installed inside melt tank 61.

Coating roller 62, which is rotated by a coating roller drive motor, which is not illustrated in the figure, of which the lower portion is dipped in molten adhesive HMA inside melt tank 61, carries the molten adhesive on the periphery thereof. By being in contact, while rotating, with lower end surface of the bundle of sheets S1, the adhesive being carried on the periphery thereof is coated onto lower edge surface SA.

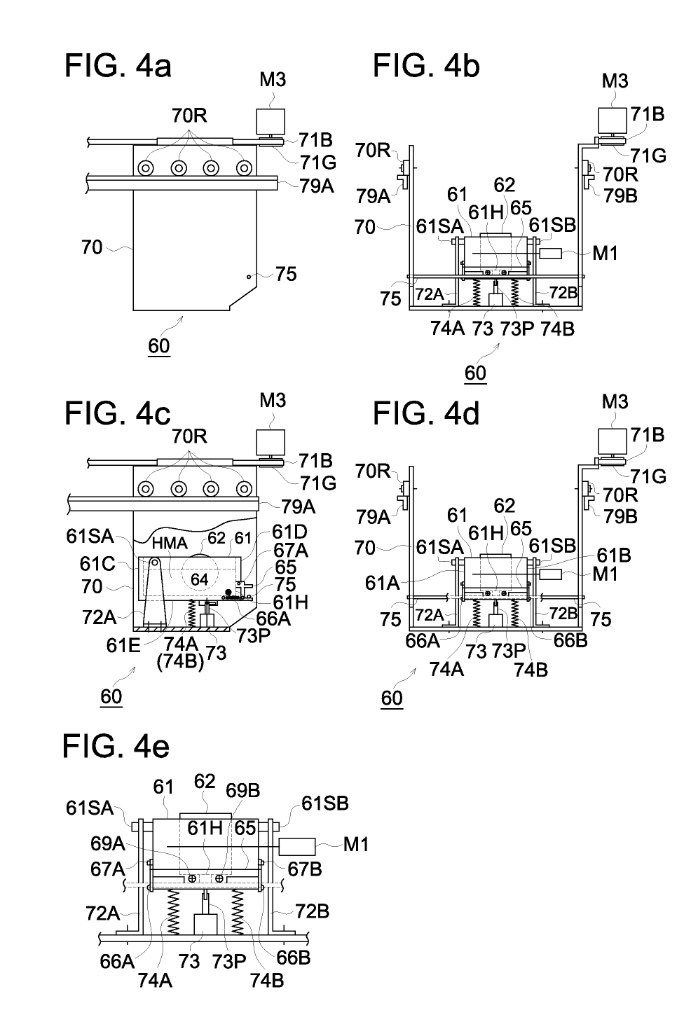

FIGS. 4a to 4e each is an explanatory diagram illustrating adhesive coating section 60.

FIG. 4a is a diagram illustrating adhesive coating section 60 viewed from the right in FIG. 2, and FIG. 4b is a right side view of adhesive coating section 60 illustrated in FIG. 4a. FIG. 4c is a diagram illustrating adhesive coating section 60 also illustrated in FIG. 4a, wherein a lateral part of the front side of movable casing 70, which will be described later, is cut partially open, FIG. 4d is a cut-away view of stopper member 75 which will be described later, and FIG. 4e is a diagram illustrating a major portion of FIG. 4d in an enlarged view.

As illustrated in FIGS. 4a, 4b, 4c, 4d, and 4e, adhesive coating section 60 includes movable casing 70 on which melt tank 61 is mounted.

Melt tank 61 is a container body with the upper end open, and is composed of side surface portions 61A, 61B, 61C, 61D, and bottom surface portion 61E, and contains molten adhesive HMA. Axis 61SA and axis 61SB are provided at the upper side of side surface portion 61A and side surface portion 61B, respectively. Also, discharge spout 61H is provided near the lower center side of side surface portion 61D and bottom surface portion 61E.

Movable casing 70 includes two parallel side portions and a bottom portion which connects the two side portions so as to have a cross-section surface in a U-shape. Also, as illustrated, a part of the bottom portion (the lower side of the right side surface of melt tank 61 illustrated in FIGS. 4a and 4c) is cut out.

On the two side portions of movable casing 70, roller 70R is rotatably provided. Movable casing 70 is provided in bookbinding apparatus B in such a manner that the movable casing is movable, by making roller 70R contact with guide plates 79A and 79B which have been affixed parallel to each other to a casing of bookbinding B, along guide plates 79A and 79B in the horizontal direction in FIG. 4a and in the direction perpendicular to the paper plain in FIG. 4b.

The shifting of movable casing 70 along guide plates 79A and 79 is carried out by driven timing belt 71B which is affixed to the upper side of one of the side portions of movable casing 70. Timing belt 71B is driven by engaging movable casing drive gear 71G which is rotated by movable casing drive motor M3.

Movable casing drive motor M3 is a stepping motor, and the rotational direction and rotational angle of the motor are controlled via bookbinding control section 30.

FIG. 4a is a diagram illustrating a state in which adhesive coating section 60 is in a home position. Owing to movable casing drive motor M3 being rotated under the control of bookbinding control section 30, movable casing 70 is shifted along guide plates 79A and 79B from the home position. By the shifting of movable casing 70, melt tank 61 mounted on movable casing 70 also shifts together with movable casing 70. Movable casing drive motor M3, which shifts movable casing 70, functions as a melt tank shifting member.

Symbols 72A and 72B are melt tank supporting aims affixed onto the bottom portion of movable casing 70. Melt tank supporting arms 72A and 72B support axis 61SA and axis 61SB, having been affixed to side surface portions 61A and 61B of melt tank 61, on each of the upper sides thereof so that melt tank 61 is supported turnably about axis 61SA and axis 61SB serving as turning centers.

Symbol 73 is a solenoid, and is affixed to the bottom portion of movable casing 70. Solenoid 73 is a type of solenoid in which movable iron core 73P is attracted into the main body of solenoid 73 when the solenoid is energized, and movable iron core 73P protrudes from the main body of solenoid 73 when the solenoid is not energized. The control of the energization or deenergization is carried out under the control of bookbinding control section 30.

Movable iron core 73P of solenoid 73 is connected to bottom surface portion 61E of melt tank 61, and supports melt tank 61 together with melt tank supporting arms 72A and 72B.

Symbols 74A and 74B are bias springs provided between the bottom portion of movable casing 70 and bottom surface portion 61E of melt tank 61. Bias springs 74A and 74B bias melt tank 61 in a direction in which the springs push up the tank, and when solenoid 73 is not energized, push up melt tank 61 about axis 61SA and axis 61SB serving as turning centers, together with movable iron core 73P, protruding (a first position) from the main body of solenoid 73, and hold melt tank so as to hold bottom surface portion 61E horizontally, in order words, keep melt tank 61 in a horizontal position. In a case in which a bookbinding system, composed of image forming apparatus A and bookbinding apparatus B, or bookbinding apparatus B performs normal image formation and bookbinding operations, melt tank 61 remains horizontal.

It should be noted that, when solenoid 73 is energized, movable iron core 73P is attracted into the main body of solenoid 73, and movable iron core 73P pulls down melt tank 61 about axis 61SA and axis 61SA of melt tank 61 serving as turning centers against a biasing force of bias springs 74A and 74B, so as to incline the bottom surface of melt tank 61. Therefore, solenoid 73 is an example of an inclining member to incline melt tank 61. The operation to incline melt tank 61 by energizing this solenoid 73 is performed only when bookbinding apparatus B operates in the adhesive discharging mode, and is not performed when bookbinding apparatus B operates in the bookbinding mode. The operation in the adhesive discharging mode will be described later. It should be noted, that although the turning of melt tank 61 in bookbinding apparatus B is carried out by the energization or deenergization of solenoid 73, it may be constituted, without depending on a solenoid, to carry out the turning via a rotary drive source such as a motor, or the like.

Symbol 62 is a coating roller, and the roller is provided rotatably, inside of melt tank 61, with an upper portion of the roller protruding from melt tank 61. Coating roller 62 is driven to rotate via coating roller drive motor M1.

Coating roller 62, of which the lower portion is dipped into molten adhesive HMA, and carries the molten adhesive HMA on the outer periphery thereof via rotation.

A heater, not illustrated in the figure, is provided at the inner bottom surface of melt tank 61, and heats and melts the adhesive stored in melt tank 61. It should be noted that the adhesive is stored in a solid form in an adhesive container, not illustrated in the figure, and in a case in which the amount of adhesive HMA becomes less than a predetermined value, more adhesive is automatically provided into melt tank 61 from the adhesive container, which is not illustrated.

Symbol 63 is a temperature sensor, and is provided near the inner bottom surface of melt tank 61. Temperature sensor 64 detects the temperature of adhesive HMA inside melt tank 61. Bookbinding control section 30 controls the operation of heater 63 based on detection results of temperature sensor 64 so as to maintain adhesive HMA inside melt tank 61 in an appropriate temperature range.

Symbol 65 is a lid member. Via pins 67A and 67B which have been affixed to melt tank 61, lid member 65 is attached turnably about pins 67A and 67B, serving as turning center.

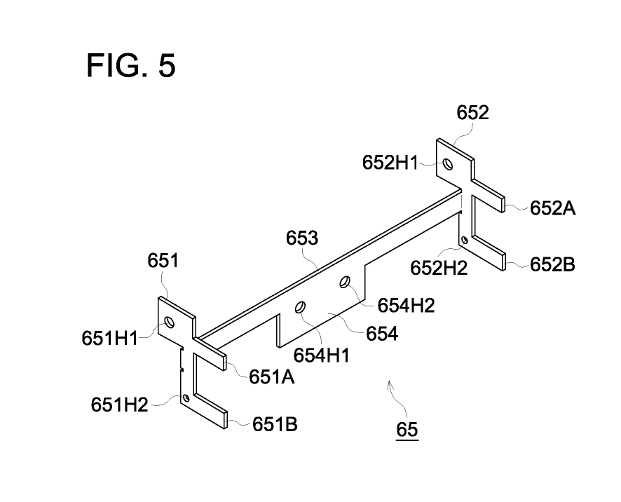

FIG. 5 is an explanatory diagram illustrating lid member 65.

Lid member 65 is constituted in a form in which supporting section 651 and supporting member 652 are connected via connecting section 653.

Supporting section 651 includes upper aim part 651A and lower aim part 651B, and is provided with pin engaging hole 651H1 and spring engaging hole 651H2. Similarly, supporting section 652 includes upper aim part 652A and lower aim part 652B, and is provided with pin engaging hole 652H1 and spring engaging hole 652H2. Connection section 653 includes discharge spout cover portion 654, and two attachment holes 654H1 and 654H2 are provided to discharge spout cover portion 652.

By engaging pin engaging hole 651H, which has been provided at supporting section 651, and pin engaging pole 652H1, which has been provided at supporting section 652, with pins 67A and 67B which have been affixed to side surface sections 61A and 61B, respectively, lid member 65 is placed to melt tank 62 turnably about pins 67A and 67B serving as turning centers.

Via pins 68A and 68B, which have been affixed to melt tank 61, and extension springs 66A and 66B, which have been mounted between spring engaging hole 651H1 and spring engaging hole 652H2, lid member 65 is biased in a direction of side surface portion 61D of melt tank 61 about pins 67A and 67B serving as turning centers, and discharge spout cover portion 654 is pressed into contact with side surface portion 61D.

By the discharge spout cover portion 654 which is pressed into contact with side surface portion 61D, discharge spout 61H, which has been provided at side surface portion 61D of melt tank 61, is covered, and thus, an outflow of the molten adhesive HMA, inside melt tank 61, through discharge spout 61H is prevented.

It should be noted that lid member 65 is movable between a position (closing position) in which discharge spout cover portion 654 covers discharge spout 61H of melt tank 61, and a position (opening position) in which discharge spout 61H of melt tank 61 is opened. When bookbinding apparatus B operates in the bookbinding mode, lid member 65 is located in the closing position in which discharge spout cover portion 654 covers discharge spout 61H of melt tank 61, and therefore, the molten adhesive HMA inside melt tank 61 does not flow out through discharge spout 61H. Lid member 65 is located in the opening position, in which discharge spout cover portion 654 opens discharge spout 61h of melt tank 61, when bookbinding apparatus operates in the adhesive discharging mode, which will be described later. It should be noted that, although the turning operation of lid member 65 in bookbinding apparatus B is performed by the turning operation of melt tank 61, it may be also constituted to carry out the turning via a rotary drive source such as a motor, or the like.

Also, symbols 69A and 69B, illustrated in FIG. 4e, are fixing screws, and threadedly engage lid member 65 to screw holes (not illustrated in the figure) via attachment holes 654H1 and 654H2, which have been provided at lid member 65 illustrated in FIG. 5, so as to fix lid member 65 in the closing position. Fixing screws 69A and 69B are removable by using a predetermined tool such as a screw driver, or an wrench. In such a manner, fixing screws 69A and 69B function as fixing members to fix lid member 65 in the state in which discharge spout 61H is closed.

Symbol 75 illustrated in FIGS. 4s, 4b, 4c, and 4d, is a stopper member. Stopper member 75 is affixed in such a manner that both ends of stopper member 75 are supported by the two parallel side portions of movable casing 70. Stopper member 75 shifts lid member 65 to the position (closing position) to cover discharge spout 61H of melt tank 61 and to the position (opening position) by turning lid member 65 about pins 67A and 67B serving as turning centers, by contacting with upper aim parts 651A and 652B and lower aim parts 651B and 652B of lid member 65 in line with the turning operation of melt tank 61.

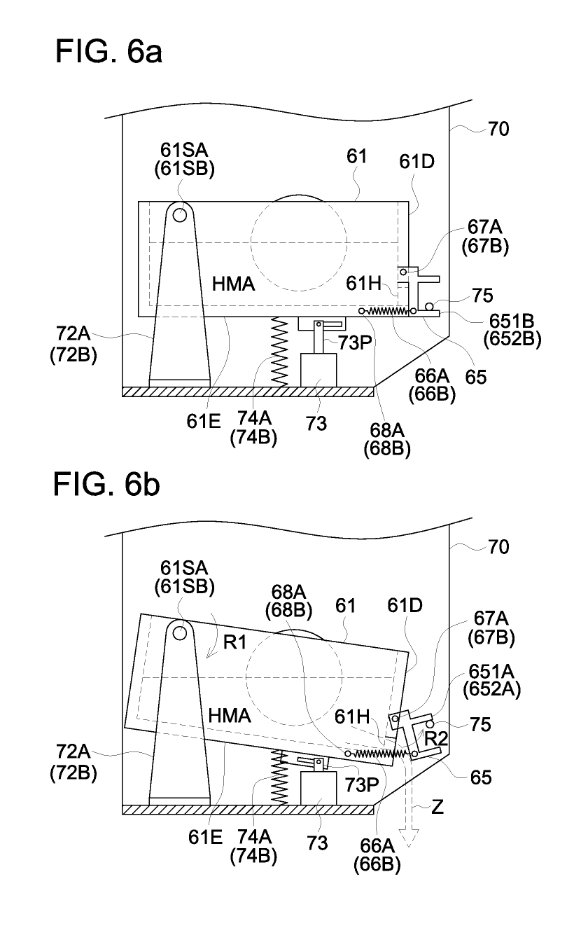

FIGS. 6a and 6b each is an explanatory diagram illustrating an operation of lid member 65 in line with a turning operation of melt tank 61. FIG. 6a is a diagram illustrating a state in which melt tank 61 is in its horizontal position, FIG. 6b is a diagram illustrating a state in which melt tank 61 is in its inclined position.

FIG. 6a is a diagram illustrating a state in which solenoid 73 is not energized. As previously described, the energization and deenergization of solenoid 73 is carried out under the control of bookbinding control section 30, and solenoid 73 is not energized when bookbinding apparatus B operates in the bookbinding mode.

Melt tank 61 is supported turnably about axis 61SA and axis 61B, which is provided behind axis 61SA, serving as turning centers, by melt tank supporting aim 72A and melt tank supporting aim 72B which is provided at the back side of the figure.

In the state in which solenoid 73 is not energized, movable iron core 73P protrudes from the main body of the solenoid, and bottom surface portion 61E of melt tank 61 is pushed up by being biased by the protruding movable iron core 73P, bias spring 74A and bias spring 74B, which is provided behind bias spring 74A. Then, the bottom surface of melt tank 61 is kept horizontal by being supported by axes 61SA and 61SB which are supported by melt tank supporting arms 72A and 72B, and also by a biasing force of movable iron core 73P, which is in a protruded position, of solenoid 73 and bias springs 74A and 74B.

Lid member 65 is provided turnably about pin 67A, which is provided to melt tank 61, and pin 67B, which is provided behind pin 67A, serving as turning centers, and via extension spring 66A and extension spring 66B which is provided behind extension spring 66A, discharge spout cover portion 654 of lid member 65 is biased in a direction to press side surface portion 61D of melt tank 61. When melt tank 61 is in its horizontal position, via a biasing force of extension springs 66A and 66B, discharge spout cover portion 654 of lid member 65 is pressed into contact with side surface portion 61D, and covers discharge spout 61H (closing position). Therefore, when melt tank 61 is in its horizontal position, molten adhesive HMA inside melt tank 61 is prevented from flowing out through discharge spout 61H. At this time, lower aim portion 651B and lower aim portion 652B behind are in contact with stopper member 75 so as to ensure a reliable abutment by lid member 65 on the side surface of melt tank 61.

FIG. 6b a diagram illustrating a state in which solenoid 73 is energized. As previously described, when bookbinding apparatus B operates in the adhesive discharging mode, solenoid 73 is energized.

When solenoid 73 is energized in the state illustrated FIG. 6a, movable iron core 73 is attracted into the main body of solenoid 73, and melt tank 61 is turned, against a biasing force of bias springs 74A and 74B in the direction indicated by arrow R1, illustrated in the figure, about axes 61SA and 61SB, serving as turning centers. With the turning of melt tank 61, the state in which the bottom surface of melt tank 61 is horizontal, under the state in which solenoid 73 is not energized, changes to the state in which the bottom surface is inclined. At this time, upper aim portion 651A and upper arm portion 652A behind are in contact with stopper member 75, and lid member 65 is turned, against a biasing force of extension springs 66A and 66B, in the direction indicated by arrow R2, illustrated in the figure, about pins 67A and 67B serving as turning centers, and discharge spout cover portion 654 is separated from side portion 61D of melt tank 61. With the separation of discharge spout cover portion 654 from side surface portion 61D, discharge spout 61H of melt tank 61 is opened, the molten adhesive HMA inside the inclined melt tank 61 flows out through discharge spout 61H. Arrow Z, illustrated in the figure, indicates adhesive HMA flowing out from melt tank 61. Also, because the bottom portion of movable casing 70 is partially cut out, adhesive HMA flows down below movable casing 70 from discharge spout 61H without interference from movable casing 70.

This turning of lid member 65 in the direction indicated by arrow R2, illustrated in the figure, driven by the abutment of upper aim portions 651A and 652A onto stopper member 75, is possible when fixing screws 69A and 69B (refer to FIG. 4e) have been removed. When fixing screws 69A and 69B are not removed, lid member 65 is not turned in the direction indicated by arrow R2, illustrated in the figure) even when solenoid 73 is energized and melt tank is turned in the direction indicated by arrow R1, illustrated in the figure, and upper arms 651A and 651B of lid member 65 is in contact with stopper member 75, and therefore, discharge spout 61H of melt tank 61 is not opened, thus, the molten adhesive inside melt tank 61 does not flow out. Therefore, contamination of the inner portion of bookbinding apparatus B or influence on the human body by contact with a high temperature adhesive, caused by unanticipated flow out of adhesive, can be prevented. In such a manner, fixing screws 69A and 69B function as a fail-safe device.

When the energization of solenoid 73 is terminated in the state illustrated FIG. 6b, movable iron core 73 protrudes from the main body of solenoid 73 and bottom surface portion 61E is pushed up by being biased by protruding movable iron core 73P and bias springs 74A and 74B, and melt tank 61 is turned in the opposite direction indicated by arrow R1, illustrated in FIG. 6b. With the turning of melt tank 61, upper aim portions 651A and 652A are separated from stopper member 75, and lid member 65 is turned in the opposite direction indicated by arrow R2 by a biasing force of extension springs 66A and 66B. With the turning of lid member 65, discharge spout cover portion 654 is pressed into contact with side surface portion 61D, and covers discharge spout 61H of melt tank 61, resulting in the state illustrated in FIG. 6a.

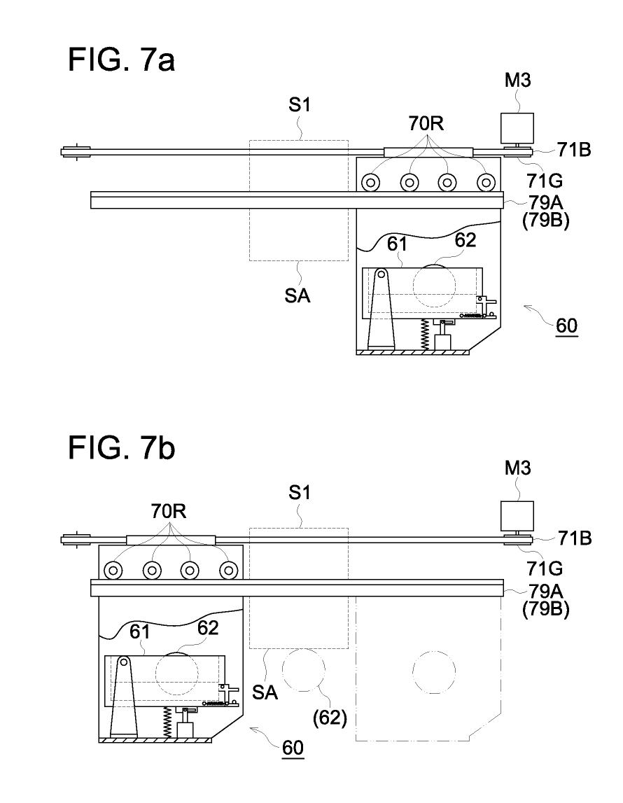

Returning to the bookbinding operation, the stage prior to coating as illustrated in FIG. 3b and the stage of coating as illustrated in FIG. 3c will be explained with reference to FIGS. 7a and 7b.

Adhesive coating section 60 is provided in bookbinding apparatus B movably along guide plates 79A and 79B by abutting roller 70R onto guide plates 79A and 79B which have been affixed in a parallel fashion to each other.

FIGS. 7a and 7b each is an explanatory diagram illustrating shifting of adhesive coating section 60.

In the stage prior to coating, adhesive coating section 60 is located in a home position which is at the right end position along guide plates 79A and 79B illustrated in FIG. 7a. When bookbinding apparatus B operates in the bookbinding mode, the operation to incline melt tank 61 in adhesive coating section 60 is not performed, and melt tank 61 is in its horizontal position.

Adhesive coating section 60 is shifted leftward from the home position, and when it reached the left end position along guide plates 79A and 79B, adhesive coating section 60 returns to the home position, namely, the position illustrated in FIG. 7a. This shifting of adhesive coating section 60 is carried out via the drive of timing belt 71B which engages movable casing drive gear 71G which is driven via movable casing drive motor M3. Movable casing drive motor M3 is a stepping motor, and its rotational direction and rotational angle are controlled by bookbinding control section 30. Adhesive coating section 60 can be shifted, via movable casing drive motor M3 which is driven under the control of bookbinding control section 30, between the home position and the left end position, or can be stopped at a prescribed position, as an example, at an adhesive discharging position, which will be described later, between the home position and the left end position.

In the process in which adhesive coating section 60 is shifted from the home position to the left end position and shifted back to the home position, coating roller 62, of adhesive coating section 60, contacts with lower edge surface SA of the bundle of sheets S1. Coating roller 62 is rotated via coating roller drive motor M1, not illustrated in the figure, and carries the molten adhesive HMA on the outer periphery thereof. Because coating roller 62 is shifted while contacting with lower edge surface SA of the bundle of sheets 51, the adhesive carried on the outer periphery of coating roller 62 is coated onto lower edge surface SA of the bundle of sheets 51.

The timing of the beginning of the shifting of adhesive coating section 60 from the home position is controlled in such a manner that a) receiving plate 506 is shifted via a driving mechanism (not illustrated in the figure) at the stage in which the bundle of sheets S1 is held as illustrated in FIG. 3c, and b) lower edge surface SA, of the bundle of sheets S1, is released and lower edge surface SA is exposed, and then c) the shifting is initiated.

When adhesive coating section 60 has coated the adhesive onto lower edge surface SA of the bundle of sheets S1, and returned to the home position, the binding of cover sheet S2 is carried out.

Cover sheet S2 is stored in cover sheet storing tray 801 of cover sheet storage section 80, and is fed via feed-out roller 802. Then, the rear end side of the sheet, in the conveyance direction, is cut via cutter 81 to an appropriate length. Cover sheet S2, having been cut, is conveyed, via horizontal belts 98A and 98B of cover sheet-conveyance shifting section 90, and placed horizontal on cover folding section 901. Horizontal belts 98A and 98B are driven via horizontal belt drive motor M7. Horizontal belt drive motor M7 is a stepping motor, and the rotational direction and rotational angle of the motor are controlled by bookbinding control section 30. Bookbinding control section 30 is capable of controlling the position of cover sheet S2, having been placed on cover holding section 901, by controlling the operation of horizontal belt drive motor M7.

It should be noted that cutter 81 cuts the rear end side of cover sheet S2, in the conveyance direction, based on the size information of sheet S1 and information of thickness of the bundle of sheets S1, having been memorized in position detect section 511, so that cover sheet S2 becomes the appropriate length. Therefore, sheets S1 in booklet S3, having been formed, and the thumb edge portion of the opening side of cover sheet S2 are aligned. Also, chips of cover sheet S2 after cutting are stored in chip box 82.

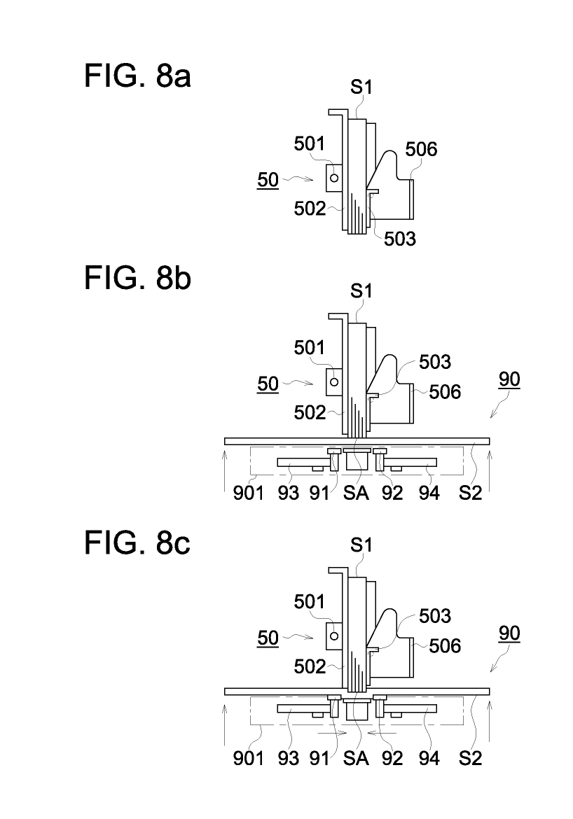

Cover folding section 901, illustrated by an alternate long and short dash line in FIGS. 8b and 8c, is composed of a plurality of members such as pressing members 91 and 92, and cams 93 and 94, which drive pressing members 91 and 92, and the like.

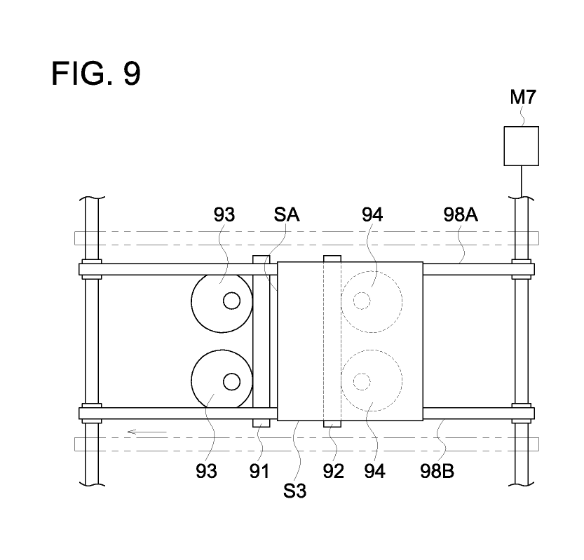

The binding of the cover sheet to the bundle of sheets is explained with reference to FIGS. 8a, 8b, and 8c and FIG. 9. FIGS. 8a, 8b, and 8c are each an explanatory diagram illustrating a step for binding the cover sheet onto the bundle of sheets, and FIG. 9 is a diagram illustrating a top view of cover folding section 901.

FIG. 8a illustrates a state in which the coating of adhesive to the bundle of sheets S1 has been completed. In the state of FIG. 8a, because cover sheet-conveyance shifting section 90 supports, as illustrated in FIG. 2, cover sheet S2 at a lower position separated from the lower surface of the bundle of sheets S1, it is not illustrated in FIG. 8a.

Cover Sheet-conveyance shifting section 90, onto which cover sheet S2 has been placed at a predetermined position, is driven to move upward via vertical belts 99A and 99B (refer to FIG. 2), and it becomes the state illustrated in FIG. 8b, and brings cover sheet S2 into contact with lower edge surface SA, namely, the adhesive coating surface. Vertical belts 99A and 99B are driven via a motor (not illustrated in the figure) under the control of bookbinding control section 30.

When cover holding section 901 is moved upward further, pressing members 91 and 92 press cover sheet S2 toward the bundle of sheets S1 from the right and left sides as illustrated in FIG. 8c, so as to give folding lines, at the boundary between the portion which becomes the spine of the booklet and the portion which becomes outside front cover, and the boundary between the portion which becomes the spine of the booklet and the portion which becomes outside back cover, and also press cover sheet S2 to sheets S1. In such a manner, cover sheet S2 is adhered to sheets S1, thus a booklet is formed.

The steps for binding cover sheet S2, illustrated in FIGS. 8a, 8b, and 8c, is initiated immediately after adhesive coating section 60 has returned to the home position illustrated in FIG. 7a. Therefore, because the steps for binding cover sheet S2 is initiated immediately after completion of coating of adhesive, the coated adhesive is prevented from drying before binding, thus adhesion failure due to desiccation is prevented.

The shifting of pressing members 91 and 92, to the right and left, is carried out via cams 93 and 94 illustrated in FIG. 9. Cams 93 and 94 are driven via a motor which is not illustrated. However, in addition to the constitution in which pressing members 91 and 92 are shifted via cams, another constitution in which racks are provided to the pressing members, and the pressing members are shifted via the rotation of pinions which engage with the racks, or the like, may be applied.

Horizontal belts 98A and 98B are driven via horizontal belt drive motor M7, and convey the cover sheet. In the state in which cover folding section 901, which is illustrated in FIG. 2, and in the state which is illustrated in FIG. 8b, horizontal belts 98A and 98B are located in the position illustrated with a solid line in FIG. 9, and support cover sheet S2 is placed thereon. However, in the step in which cover folding section 901 is moved upward as illustrated in FIG. 8c, or in the step in which cover folding section 901 is moved downward from the elevated position, horizontal belts 98A and 98B are located in a retracted position illustrated by an alternate long and two short dashes line in FIG. 9, and do not interfere with the ascent and descent of cover folding section 901.

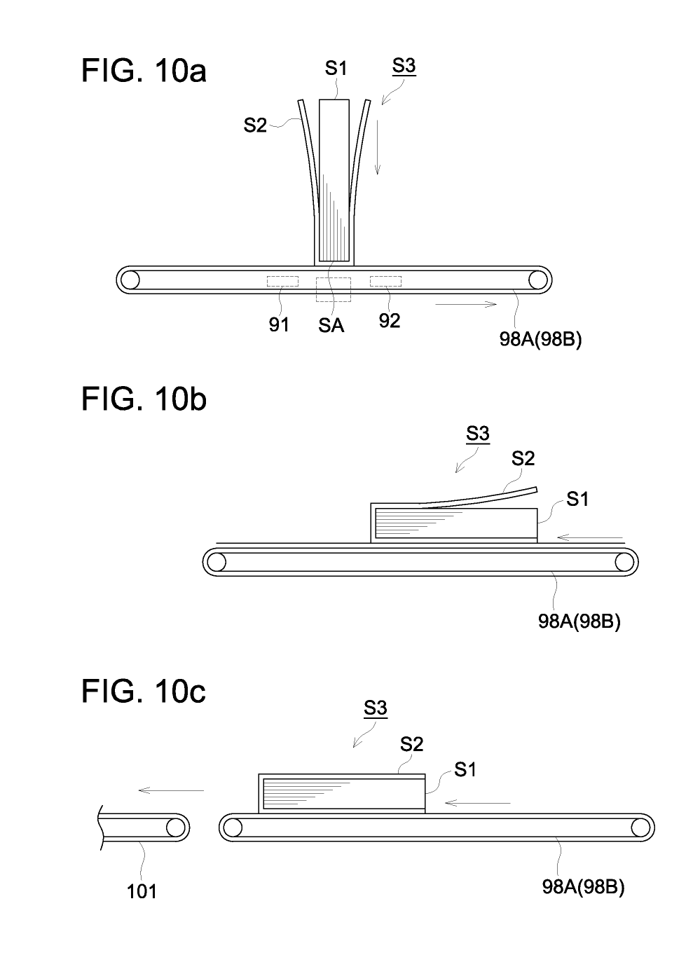

The processing of cover sheet S2 after the binding of cover sheet S2 will now be described with reference to FIG. 10.

When the binding of cover sheet S2 is complete, cover sheet-conveyance shifting section 90 is driven to descend via horizontal belts 98A and 98B, and returns to the home position. Horizontal belts 98A and 98B also return to the position illustrated by a solid line in FIG. 9.

Next, with holding plate 503 shifted to the hold releasing position, pressing members 91 and 92 release the pressure force. Due to this, booklet S3, composed of sheets S1 and cover sheet S2, slides down on horizontal belts 98A and 98B. FIG. 10a illustrates the state in which booklet S3 is supported by horizontal belts 98A and 98B in this way.

In the state illustrated in FIG. 10a, when horizontal belts 98A and 98B initiate a shift in the direction indicated by the arrow, booklet S3 is conveyed via horizontal belts 98A and 98B to the left and conveyed via horizontal belts 98A and 98B in the state in which booklet S3 has fallen to the right, as illustrated in FIG. 10b.

Sheet discharging table 101, in booklet discharging section 100, is shifted in the vertical direction via a belt drive. Booklet S3 is conveyed from horizontal belts 98A and 98B onto sheet discharging table 101, which has been shifted to the same height of horizontal belts 98A and 98B which convey booklet S3, and discharged from bookbinding apparatus B.

It should be noted that when stacking section 50 is in the state illustrated in FIG. 10a, namely, along the operation in which holding plate 503 is shifted to the hold releasing position, stacking section 50 is rotated and is arranged in an inclining state as illustrated in FIG. 2, and bookbinding for the following sheet S1 becomes possible.

Also, when stacking section 50 is in the state illustrated in FIG. 3a, namely, in the period from when stacking section 50 is rotated from the inclining state to the vertical state until when stacking section 50 returns to the inclining state from the vertical state through the stage illustrated in FIG. 10a, the coating of the adhesive via adhesive coating section 60 and the binding of cover sheet S2 are carried out, but, even in this period, bookbinding apparatus B is capable of receiving sheets S1 continuously ejected from image forming apparatus A.

In other words, by having a constitution in which, during stacking section 50 returns from the vertical state to the inclining state, sheets S1, having been ejected from image forming apparatus A, are temporarily stacked on reversing guide 402, and, at the time when stacking section 50 returns to the inclining state, sheets S1, having been stacked on reversing guide 402, are conveyed to stacking section 50, it is possible to improve work efficiency of a bookbinding system which consists of bookbinding apparatus A and image forming apparatus B.

A hot-melt type adhesive deteriorates when it is heated over a prolonged period of time. The deterioration includes a change of color, staining, generation of an odor, production of solid materials, and the like, and becomes a cause to degrade the bookbinding quality, or to exert an adverse influence on installed environment of the bookbinding apparatus. Bookbinding apparatus B is capable of discharging the adhesive inside the melt tank easily and safely when operating in the adhesive discharging mode.

Although bookbinding apparatus B is constituted to operate the bookbinding mode under normal conditions, an operator or a person in charge of maintenance service can operate bookbinding apparatus B in the bookbinding mode by manipulating mode switching input section 38 in bookbinding apparatus B.

When an operator or a person in charge of maintenance service determines that the adhesive inside melt tank 61 has deteriorated, judging from color change at adhered portions in formed booklets, degradation of bookbinding quality due to adherence of solid materials, or the like, an odor from bookbinding apparatus B, or the like, the operator or the person in charge of maintenance service can operate bookbinding apparatus B in the adhesive discharging mode and discharge the adhesive inside melt tank 61 easily and safely.

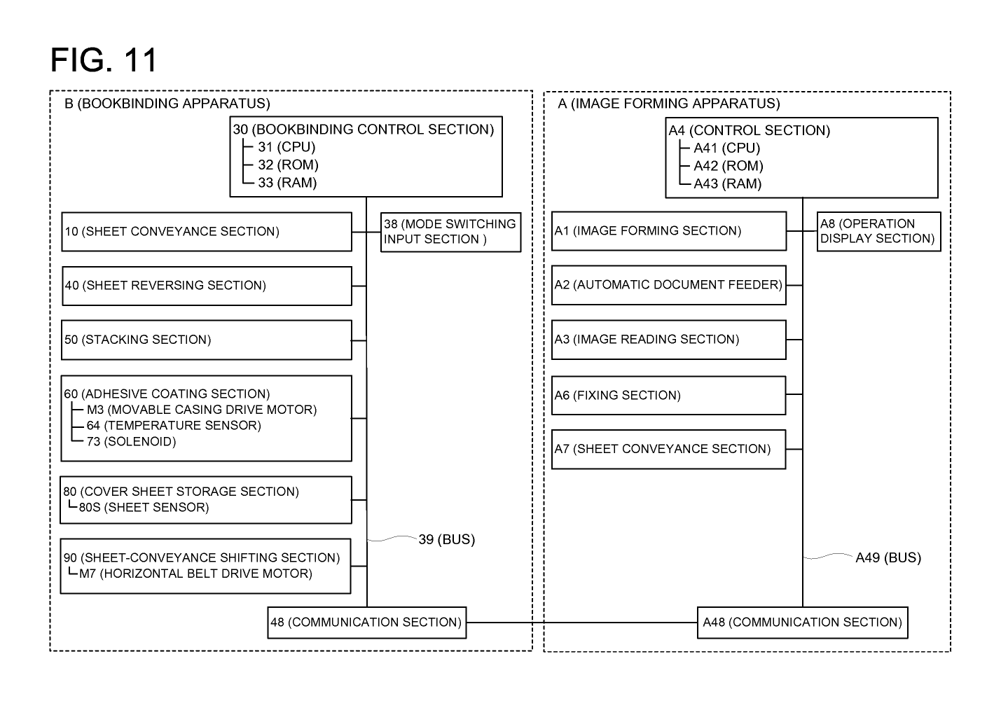

FIG. 11 is a block diagram illustrating a control system for controlling a bookbinding system according to this preferred embodiment. Bookbinding apparatus B is constituted so as to operate in conjunction with image forming apparatus A.

It should be noted that, in FIG. 11, relevant portions necessary to describe operation of the preferred embodiment and their peripheries are mainly shown, and other known portions as a bookbinding system are omitted.

Symbol A4 in image forming apparatus A is a control section. Control section A4 is a computer system including, but not limited to, CPU (A41), ROM (A42), and RAM (A43). Control section A4 is configured to function as a control section not only to control operations of image forming section A1, automatic document feeder A2, image reading section A3, fixing section A6, sheet conveyance section A7, and operation display section A8, but also to control operations of bookbinding apparatus B so as to control operations of bookbinding system together with bookbinding control section 30 of bookbinding apparatus B, which will be described later.

CPU (A41) controls each operation of image forming apparatus A based on job conditions input via operation display section A8 by carrying out programs having been stored in ROM (A42), and carries out image formation onto sheet S1 and ejects sheet S1 to bookbinding apparatus B. Also, by controlling control section 30 of bookbinding apparatus B, CPU (A41) operates bookbinding apparatus B in conjunction with image forming operations of image forming apparatus A.

ROM (A42) stores programs to operate image forming apparatus A and bookbinding apparatus B based on job conditions input via operation display section A8.

RAM (A43) is capable of storing and reading out a plurality of information, and stores data having been generated or obtained when CPU (A41) carries out controls of image forming apparatus A and bookbinding apparatus B.

Communication section (A48) functions as a communication section, and connected to communication section (48) of bookbinding apparatus B, and sends or receives a variety of information for image forming apparatus A and bookbinding apparatus B to operate in association with each other.

Symbol A49 is a bus. Each part of image forming apparatus A is connected to bus (A49) together with control section A4, thus making it possible to mutually communicate information.

Control section A4 controls each device and mechanism, having been connected to bus (A49), based on job information input via operation display section A8 so as to carry out image formation, based on job information, onto sheet S1 having been selected based on job information.

Also, communication section (A48), having been connected to bus (A49), is connected to communication section (48) of bookbinding apparatus B, thus making it possible to send or receive information between image forming apparatus A and bookbinding apparatus B. Included in the information which is sent or received between image forming apparatus A and bookbinding apparatus B, is, but not limited to, information which indicates that image forming apparatus A is executing an image forming job, information which indicates whether or not the job, being in execution, is to carry out a case binding, and information which indicates the number of sheets S1 to constitute a booklet when case binding is carried out.

Then, control section A4 is configured to control image forming apparatus A so as to carry out conveyance of sheets and image formation based on job information, having been input, and also to control bookbinding control section 30 of bookbinding apparatus B, having been connected, so as to control to carry out a post-processing based on job information, having been input.

Symbol 30 is a bookbinding control section of bookbinding apparatus B. Bookbinding control section 30 is a computer system including, but not limited to, CPU (31), ROM (32), and RAM (33). Bookbinding control section 30 is configured to control the operations of sheet conveyance section 10, sheet reversing section 40, stacking section 50, adhesive coating section 60, cover sheet storage section 80, cover sheet-conveyance shifting section 90, and mode switching input section 38.

CPU (31) controls operations of each part of image forming apparatus A by carrying out programs, having been stored in ROM (32).

ROM (32) stores a bookbinding program with which bookbinding apparatus B operates in the bookbinding mode, and stores an adhesive discharging mode program with which bookbinding apparatus B operates in the adhesive discharging mode.

The bookbinding mode program is a program to control bookbinding apparatus B to stack sheets S1, having been ejected from image forming apparatus A, on stacking section 50 to form a bundle of sheets S1, and discharge a booklet after carrying out a case binding, or to operate bookbinding apparatus B in the bookbinding mode in which sheets S1, having been ejected from image forming apparatus A are ejected onto sheet-ejection tray 20.

The adhesive discharging program is a program to control bookbinding apparatus B to operate in the adhesive discharging mode in which the adhesive, having been stored in melt tank 61, is discharged.

Also, ROM (32) stores image information of screen 38G1, screen 38G2, screen 38G3, screen 38G4, and screen 38G5 which are displayed in mode switching input mode 38. Screens 38G1 to 38G5 will be described later.

CPU (31) operates bookbinding apparatus B in the bookbinding mode under normal conditions, and when adhesive discharging mode execution instruction information is input via mode switching input section 38, CPU (31) operates bookbinding apparatus B in the adhesive discharging mode.

RAM (33) is capable of storing and reading out a plurality of information, and stores data having been generated or obtained when CPU (31) carries out controls of image forming apparatus A and bookbinding apparatus B.

Communication section (48) functions as a communication section, and is connected to communication section (A48) of image forming apparatus A, and sends or receives a variety of information for image forming apparatus A and bookbinding apparatus B to operate in association with each other.

Symbol 39 is a bus. Each part of bookbinding apparatus B is connected to bus (39) together with bookbinding control section 30, thus making it possible to mutually communicate information.

Also, communication section (48), having been connected to bus (39), is connected to communication section (A48) of image forming apparatus A, thus making it possible to send or receive signals between image forming apparatus A and bookbinding apparatus B. Included in the signals which are sent or received between image forming apparatus A and bookbinding apparatus B, are, but not limited to, a signal which indicates that image forming apparatus A is executing an image forming job, a signal which indicates whether or not the job, being in execution, is to carry out case binding, and a signal which indicates the number of sheets S1 to constitute a booklet when case binding is to be carried out.

Then, when CPU (31) operates bookbinding apparatus B in the bookbinding mode, CPU (31), in conjunction with the operations of image forming apparatus A, controls operations of each part of bookbinding apparatus B based on job information input via operation display section A8 so as to control to carry out post-processing based on job information, having been input. In other words, based on job information, having been input, CPU (31) operates bookbinding apparatus B to perform case binding process with respect to the sheets S1 received from image forming apparatus A, or ejects sheets S1 outside the bookbinding apparatus without performing the case binding process.

CPU (31) operates bookbinding apparatus B based on the adhesive discharging mode when the adhesive discharging mode execution instruction information is input via mode switching input section 38. When CPU (31) operates bookbinding apparatus B based on the adhesive discharging mode, CPU (31) controls bookbinding apparatus B to discharge the adhesive from melt tank 61 of adhesive coating section 60.

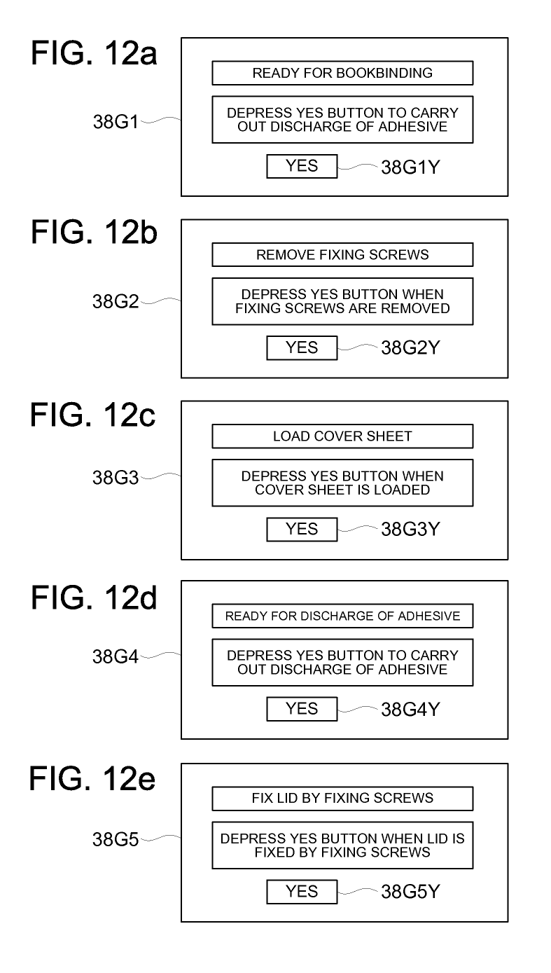

FIGS. 12a, 12b, 12c, 12d, and 12e are each a diagram illustrating an example of a screen displayed on mode switching input section 38. Information of screens, to be displayed in mode switching input section 38, have been stored in RAM (32). Either one of screens 38G1 through 38G5 is read out, and is displayed in mode switching input section 38 under the control of CPU (31). Also, via depression (touching) of the YES button, which is to be displayed on each screen, by an operator or a person in charge of maintenance, it is possible to transmit the judgment result of the operator or the person in charge of maintenance, or progress to CPU (31).

FIG. 12a illustrates screen 38G1. On screen 38G1, a message is displayed which indicates that bookbinding apparatus B is in a state to operate in the bookbinding mode and is possible for bookbinding. Also, displayed are a message, which prompts an operator or a person in charge of maintenance to depress the YES button when discharge of the adhesive is to be carried out, and YES button 38G1Y.

FIG. 12b illustrates screen 38G2. This screen is displayed when the “YES button” on screen 38G1 is depressed and bookbinding apparatus B initiates an operation in the adhesive discharging mode. On screen 38G2, displayed are messages which prompt an operator or a person in charge of maintenance to remove fixing screws 69A and 69B and to depress the YES button when the fixing screws have been removed, and YES button 38G2Y.

FIG. 12c illustrates screen 38G3. This screen is displayed in cases in which cover sheet S2 is not stored in cover sheet storage section 80 when bookbinding apparatus B operates in the adhesive discharging mode. On screen 38G3, displayed are messages which prompt an operator or a person in charge of maintenance to load cover sheet S2 in cover sheet storage section 80 and to depress the YES button when cover sheet S2 has been loaded in cover sheet storage section 80, and YES button 38G3Y.

FIG. 12d illustrates screen 38G4. On screen 38G4, displayed is a message which indicates that bookbinding apparatus B is ready to carry out discharge of the adhesive. Also, displayed are a message, which prompts an operator or a person in charge of maintenance to depress the YES button when discharge of the adhesive is to be initiated, and YES button 38G1Y.

FIG. 12e illustrates screen 38G5. This screen is displayed when discharge of the adhesive from melt tank 61 has been completed. On screen 38G5, displayed are messages which prompt an operator or a person in charge of maintenance to fix the lid (lid member 65) to melt tank 61 by fixing screws 69A and 69B and to depress the YES button when the lid (lid member 65) is affixed, and YES button 38G3Y.

Bookbinding apparatus B operates in the bookbinding mode under normal conditions, and carries out post-processing in conjunction with the image forming operations of image forming apparatus A. When the adhesive discharging mode execution instruction information is input via mode switching input section 38, bookbinding apparatus B operates in the adhesive discharging mode, and returns to the bookbinding mode when a series of operations concerning discharge of adhesive, including the discharge of the adhesive from melt tank 61, has been completed.

Next, an operation of bookbinding system, composed of image forming apparatus A and bookbinding apparatus B according to the preferred embodiment of the present invention, will now be described.

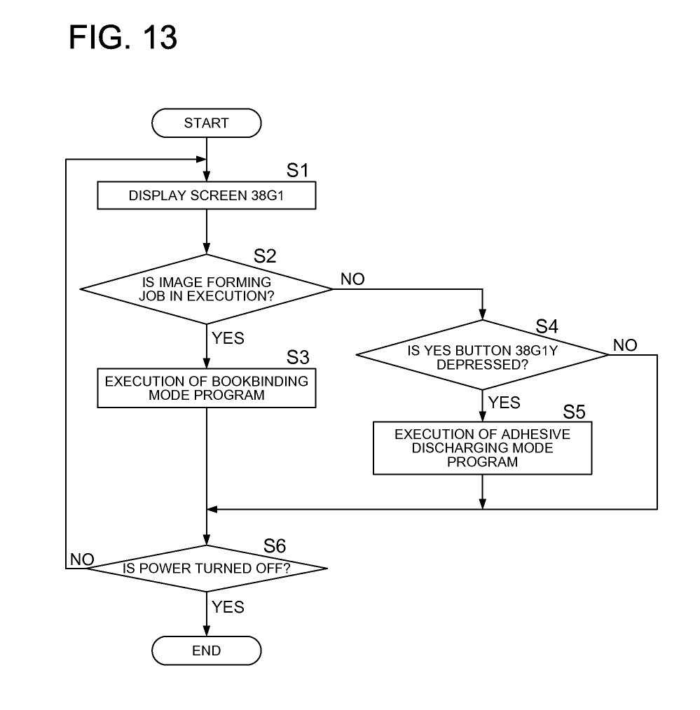

FIG. 13 is an explanatory flow chart illustrating control operation of bookbinding apparatus B in a bookbinding system according to a preferred embodiment of the present invention.

CPU (31) of bookbinding apparatus B displays screen 38G1 (refer to FIG. 12a) in mode switching input section 38 in step S1.

Next, CPU (31) confirms, in step S2, whether or not image forming apparatus A is executing an image forming job. In the case in which image forming apparatus A is executing an image forming job, a signal which indicates that image forming apparatus A is executing an image forming job is transmitted so that whether or not image forming apparatus A is executing an image forming job can be confirmed by existence or non-existence of the signal. In the case in which image forming apparatus A is executing an image forming job (step S2: YES), the process flow advances to step S3.

In step S3, CPU (31) executes the bookbinding mode program and controls operations of each part of bookbinding apparatus B in the bookbinding mode, and carries out a post-processing based on job information transmitted from image forming apparatus A. In other words, CPU (31) carries out post-processing with respect to sheets 51, which have been received from image forming apparatus A, based on job information. Then, the process flow advances to step S6.

On the other hand, in the case in which image forming apparatus A is not executing an image forming job (step S2: NO), the process flow advances to step S4 and confirmed is whether or not YES button 38G1Y, which is displayed on screen 38G1, has bee depressed. In the case in which YES button 38G1Y has been depressed (step S4: YES), the process flow advances to step S5.

In step S5, CPU (31) executes the adhesive discharging mode program and controls operations of each part of bookbinding apparatus B in the adhesive discharging mode, and discharges the adhesive, having been stored in melt tank 61. It should be noted that details of control operations of CPU (31) in step S5 will be described later.

Also, in the case in which YES button 38G1Y is not depressed in step S4 (step S4: NO), the process flow advances to step S6.

In step S6, confirmed is whether or not the power source for bookbinding apparatus B is turned off. The power source of bookbinding apparatus B is turned off directly via a power switch (not illustrated in the figure) which is provided to bookbinding apparatus B, or is turned off indirectly via a power switch (not illustrated in the figure) which is provided to image forming apparatus A. In the case in which the power source of bookbinding apparatus B is not turned off (step S6: NO the process flow returns to step S1. The steps of steps S1 through S6 are iteratively implemented until the power source of bookbinding apparatus B is turned off, and the control operations of CPU (31) is finished when the power source is turned off (step S6: YES). In this way, CPU (31) displays screen 38G1 in mode switching input section 38 under normal conditions, and operates bookbinding apparatus B in the bookbinding mode when YES button 38G1Y, which is displayed in mode switching input section 38, is not depressed, and operates bookbinding apparatus B in the adhesive discharging mode only when YES button 38G1Y, which is displayed in mode switching input section 38, has been depressed.

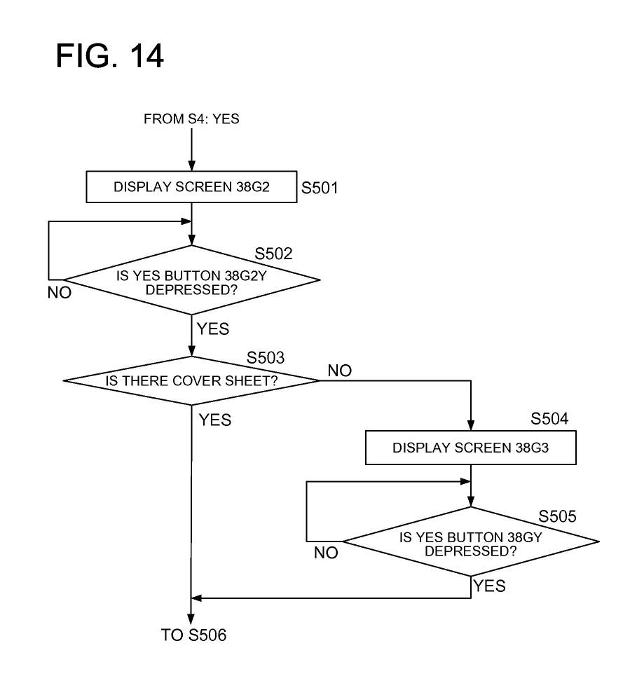

Details of the control of bookbinding apparatus B in the adhesive discharging mode to be executed in step S5 in FIG. 13 will be explained with reference to FIGS. 14, 15, 16a and 16b.

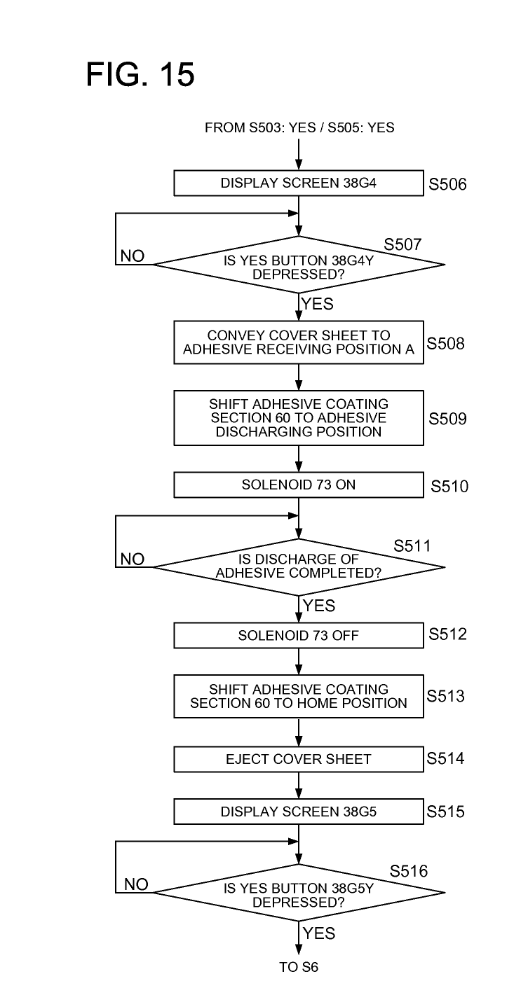

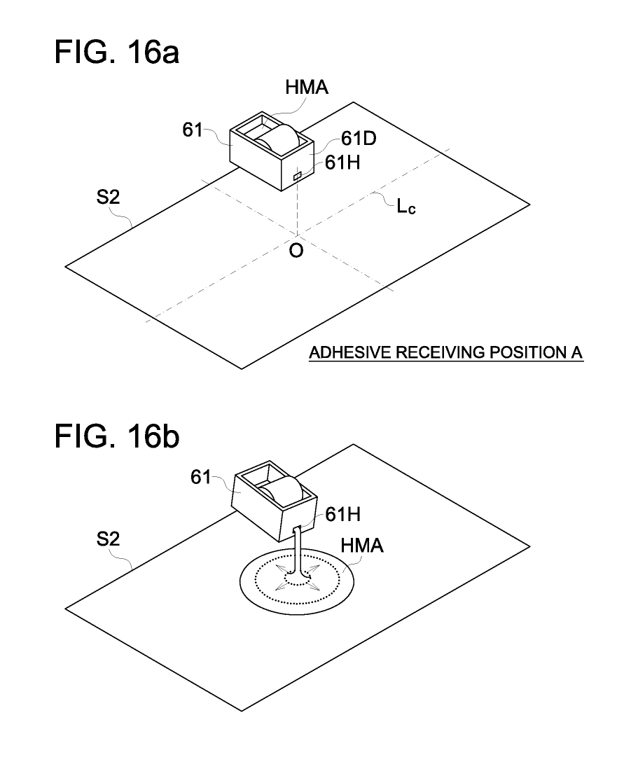

FIG. 14 is a flow chart illustrating a first half of details of step S5 in FIG. 13 expanded into steps S501 to S505. FIG. 15 is a flow chart illustrating a last half of details of step S5 in FIG. 13 expanded into steps S506 to S516. Also, FIGS. 16a and 16b are each an explanatory diagram illustrating a positional relationship between melt tank 61 and a cover sheet when bookbinding apparatus B operates in the adhesive discharging mode and discharges adhesive.

As previously described, when YES button 38G1Y, displayed on screen 38G1 which has been displayed in step S4 in FIG. 13, is depressed by an operator or a person in charge of maintenance (step S4: YES), the process flow advances to step S5.

When the process flow advanced to step S5, CPU (31) displays screen 38G2 in step S501 in the process flow chart illustrated in FIG. 14. Then, CPU (31) waits until the operator or the person in charge of maintenance removes fixing screws 69A and 69B, threadably mounted on melt tank 61 of adhesive coating section 60 which is located in the home position, and depresses YES button 38G2Y on screen 38G2. When YES button 38G2Y has been depressed (step S502: YES), the process flow advances to step S503.

In step S502, confirmed is whether or not cover sheet S2 is stored in cover sheet storage section 80. Whether or not cover sheet S2 is stored in cover sheet storage section 80 is detected via sheet sensor 80S of cover sheet storage section 80. When CPU (31) confirmed based on detected results that cover sheet S2 is stored in cover sheet storage section 80 (step S503: YES), the process flow advances to step S504 (refer to FIG. 15). Also, when it is confirmed that no cover sheet S2 is stored in cover sheet storage section 80 (step S503: NO), the process flow advances to step S504.

CPU (31) displays screen 38G3 in step S504. Then, CPU (31) waits until an operator or a person in charge of maintenance loads cover sheets S2 in cover sheet storage section 80, and depresses YES button 38G3Y on screen 38G3. When YES button 38G3Y is depressed (step S505: YES), the process flow advances to step S506 (refer to FIG. 15).

CPU (31) displays screen 38G4 in step S506 in FIG. 15. Then CPU (31) waits until an operator or a person in charge of maintenance depresses YES button 38G3Y on screen 38G3.

When YES button 38G4Y is depressed (step S507: YES), the process flow advances to step S508.

In step S508, CPU (31) conveys cover sheet S2, having been stored in cover sheet storage section 80, to adhesive receiving position A by controlling the operations of cover sheet-conveyance shifting section 90.

Adhesive receiving position A is a position in which the center of front end and back end, in the conveyance direction, of cover sheet S2 which is placed on horizontal belts 98A and 98B, coincides with the center of cover sheet holding section 901. CPU (31) carries out the conveyance of cover sheet S2 to adhesive receiving position A by controlling the operations of horizontal belt drive motor M7 which drives horizontal belts 98A and 98B.

CPU (31), in step S509, shifts adhesive coating section 60 to the adhesive discharging position from the home position when cover sheet S2 has been conveyed to adhesive receiving position A.

The adhesive discharging position is the position in which side surface portion 61D (at which discharge spout 61H is provided) of melt tank 61 (the bottom surface of which is kept horizontal) is positioned immediately above the center between the two sides, parallel to the conveyance direction, of cover sheet S2, having been conveyed to adhesive receiving position A. CPU (31) carries out the shifting of adhesive coating section 60 to the adhesive discharging position by controlling the operations of movable casing drive motor M3 which shifts adhesive coating section 60.

FIG. 16a is an explanatory diagram illustrating cover sheet S2, having been shifted to adhesive receiving position A, and melt tank 61, having been shifted to the adhesive discharging position.

Side surface portion 61D of melt tank 61, having been shifted to the adhesive discharging position, is positioned immediately above the center (center line L_{c}) of two sides, parallel to the conveyance direction, of cover sheet S2, having been conveyed to adhesive receiving position A. Therefore, as illustrated, discharge spout 61H of melt tank 61, having been shifted to the adhesive discharging position, is positioned immediately above center O of cover sheet S2, having been conveyed to adhesive receiving position A. It should be noted that, in this state, because the bottom surface of melt tank 61 is kept horizontal and discharge spout 61H is covered by lid member 65 (not illustrated in the figure), adhesive HMA inside melt tank 61 does not flow out through discharge spout 61H.

Referring to FIG. 15 again, CPU (31) energizes solenoid 73 (solenoid 730N) in step S510 subsequent to step S509.

As solenoid 73 is energized, melt tank 61 is turned, and the bottom surface becomes an inclined state. As melt tank 61 is turned, upper side arm portion 651A and lower side arm portion 652B behind of lid member 65 come into contact with waiting member 75, and lid member 65 is turned in the direction of arrow R2, illustrated in FIG. 6b, and discharge spout cover portion 654 is separated from side surface portion 61D of melt tank 61. As discharge spout cover portion 654 is separated from side surface portion 61D of melt tank 61, discharge spout 61H of melt tank 61 is opened, and adhesive HMA, having been stored in melt tank 61, flows out through discharge spout 61H, namely, adhesive HMA is discharged. Adhesive HMA, having been discharged from melt tank 61, flows downward to substantially the central position of cover sheet S2, having been conveyed to adhesive receiving position A, and is received by cover sheet S2. Although adhesive HMA, having been received by cover sheet S2, flows along the surface of cover sheet S2 toward the periphery of cover sheet S2 in a substantially concentric fashion around the position (hereinafter referred to as flow-down position) when the adhesive is received by cover sheet S2, adhesive HMA is cooled and solidifies upon exposure to air and contact with cover sheet S2, and adhered onto cover sheet S2. FIG. 16b is an explanatory diagram illustrating a state in which adhesive HMA flows down from discharge spout 61H of melt tank 61, which has been turned, and is received by cover sheet S2. As illustrated, adhesive HMA, having been received by cover sheet S2, flows and spreads along the surface of cover sheet S2 toward the periphery of cover sheet S2 in a substantially concentric fashion around the flow-down position. Then, as time advances, adhesive HMA is cooled, and stops flowing and is adhered onto cover sheet S2.

CPU (31) energizes solenoid 73 in step S510 and initiates the discharge of adhesive HMA having been stored in melt tank 61, and then waits until completion of discharge of adhesive HMA from melt tank 61 in step S511.

Installed inside melt tank 61, is temperature sensor 64, which detects the temperature of adhesive HMA. When temperature sensor is dipped into molten adhesive HMA stored in melt tank 61, the sensor detects the temperature of molten adhesive HMA, and when adhesive HMA inside melt tank 61 has been discharged, the temperature sensor is no longer dipped in adhesive HMA, and therefore, the detected temperature drops. CPU (31) determines, when operating in the adhesive discharging mode, that adhesive HMA has been discharged from melt tank 61 (step S511: YES) by detecting a drop in the detected temperature by temperature sensor 64, and process flow advances to step S512.

In step S512, the energization of solenoid 73 is turned off (solenoid 73 OFF).

As the energization of solenoid 73 is turned off, melt tank 61 is turned, by a biasing force of bias springs 74A and 74B, in the opposite direction of arrow R1, illustrated in FIG. 6b, namely, in the direction in which the bottom surface thereof becomes horizontal. As melt tank 61 turns, upper aim portion 651A and upper aim portion 652A behind of lid member 65 are separated from stopper member 75, and, by a biasing force of extension springs 66A and 66B, discharge spout cover portion 654 of lid member 65 is turned in the opposite direction of arrow 2, illustrated in FIG. 6b, and is pressed into contact with side surface portion 61D of melt tank 61, and covers discharge spout 61H of melt tank 61. At this time, lower arm portion 651B and lower arm portion 652B behind of lid member 65 come into contact with stopper member 75 so as to ensure the contact of discharge spout cover portion 654 into the side surface of melt tank 61.

As the bottom surface of melt tank 61 turns to the horizontal position, CPU (31), in step S513, shifts adhesive coating section 60, which is in the adhesive discharging position, to the home position by controlling the operations of movable casing drive motor M3. Then, in the following step S514, CPU (31) ejects cover sheet S2, which is in adhesive receiving position A and adhesive HMA has been adhered thereon, to booklet ejecting section 100.

CPU (31) displays screen 38G5, in step S515, after ejecting cover sheet S2 to booklet ejecting section 100. Then CPU (31) waits until an operator or a person in charge of maintenance fixes the lid (lid member 65) to melt tank 61 via fixing screws 69A and 69B, having been removed to discharge adhesive, and depresses YES button 38G5Y on screen 38G5. When YES button 38G5Y is depressed (step S516: YES), CPU (31) completes the series of operations in the adhesive discharging mode, and the process flow advances to step S6 in FIG. 13.

Cover sheet S2, which has been ejected to booklet ejecting section 100 in step S514 and adhesive HMA has been adhered thereon, can be removed easily and safely by the operator or the person in charge of maintenance.

In such a manner, bookbinding apparatus B is capable of removing the deteriorated adhesive from melt tank 61 efficiently, and easily and safely by operating in the adhesive discharging mode.

In the adhesive discharging mode described previously, bookbinding control section 30 flows adhesive from melt tank 61 down onto the substantially central portion of cover sheet S2 which has been shifted to adhesive receiving position A. In other words, the opposing position, between melt tank 61 of the time of discharging adhesive and cover sheet S2 of the time of receiving adhesive, remains constant, and adhesive flows down from melt tank 61 onto the substantially central portion of cover sheet S2. The adhesive, received by cover sheet S2, flows, spreads, cools, and solidifies as time advances, and adhered onto cover sheet S2. The adhesive flows and spreads, substantially concentrically around the flow-down position, toward the periphery of cover sheet S2. Therefore, discharge of adhesive from melt tank 61 is possible within the range in which the flowing and spreading adhesive does not exceed the periphery of cover sheet S2.

In the meantime, cover sheet S2 is constituted in such a manner that its length, in a longitudinal direction, is longer than the length in a direction perpendicular to the longitudinal direction (hereinafter, referred to as width direction) because the loner direction of cover sheet S2 becomes the outside front cover portion, the spine portion of the booklet, and the outside back cover portion. Therefore, discharge of adhesive from melt tank 61 is possible within the range in which the adhesive, which flows and spreads toward the periphery of cover sheet S2, does not exceed the sides of width direction of cover sheets S2. On the other hand, it gives room for the adhesive to flow, spread and reach the sides of the longer direction.

A bookbinding apparatus, according to a second embodiment of the present invention, enables discharge of more amount of adhesive from melt tank 61 by spreading the adhesive, which has been received by cover sheet S2, over the entire area of cover sheet S2.

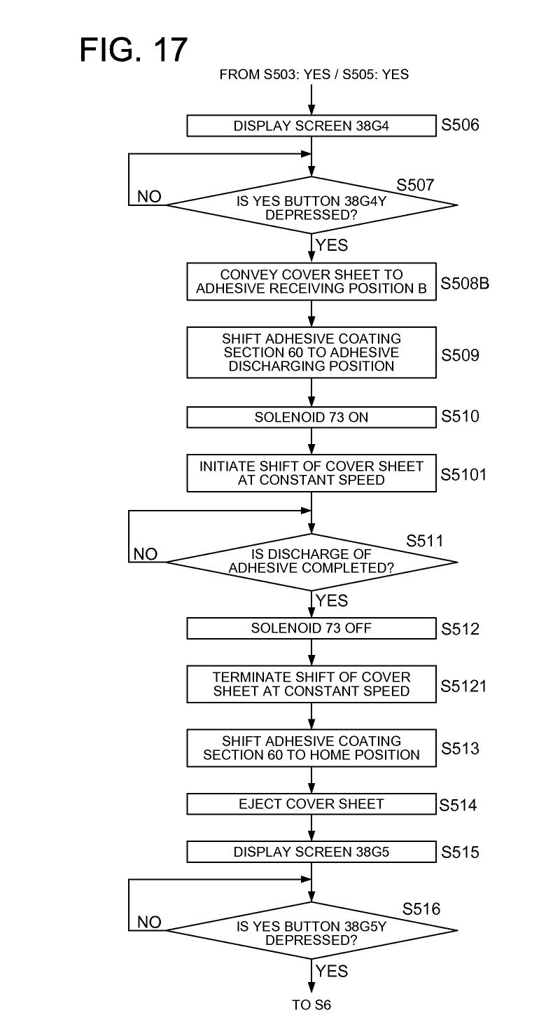

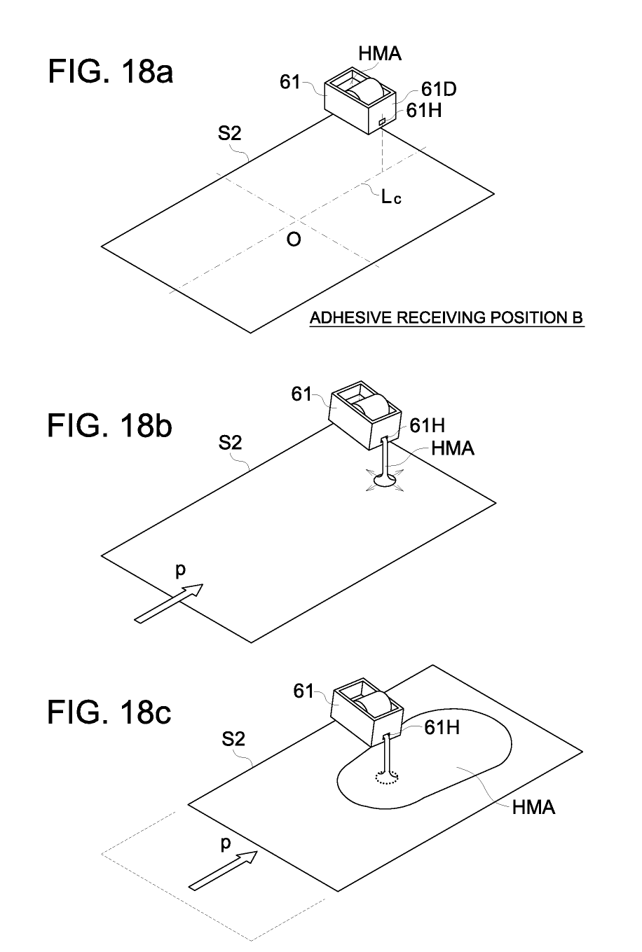

An operation of the bookbinding apparatus according to the second embodiment of the present invention will now be described with reference to FIGS. 17, 18a, 18b, and 18c.

FIG. 17 is an explanatory flow chart illustrating an operation of a bookbinding apparatus according to the second preferred embodiment of the present invention, and is a flow chart illustrating a last half of details of step S5 in FIG. 13 expanded into steps S506 to S516. It should be noted that the first half of details of step S5 is the same as steps S501 to S505 of the flow chart illustrated in the previously described FIG. 14. Also, in the flow chart illustrated in FIG. 17, explanations will be omitted partially because the steps, which are the identical step numbers in the flow chart illustrated in the previously described FIG. 15, perform the same operations in the flow chart illustrated in FIG. 15. Also, FIGS. 18a, 18b, and 18c are each an explanatory diagram illustrating a positional relationship between melt tank 61 and the cover sheet when the bookbinding apparatus, according to the second preferred embodiment, operates in the adhesive discharging mode and discharges adhesive.

When YES button 38G1Y, displayed on screen 38G1 in step S4 in the above-mentioned FIG. 13, is depressed (step S4: YES) by an operator or a person in charge of maintenance, the process flow advances to step S5.

When advanced to step S5, the process flow advances to step S506, illustrated in FIG. 17, through steps S501 to S505 in FIG. 14.

Screen 38G4 is displayed in step S506, and CPU (31) waits until an operator or a person in charge of maintenance depresses YES button 38G4Y on screen 38G4.

When YES button 38G4Y is depressed (step S507: YES), the process flow advances to step S508C.

CPU (31) conveys cover sheet S2, having been stored in cover sheet storage section 80, to adhesive receiving position B by controlling the operations of cover sheet-conveyance shifting section 90.

Adhesive receiving position B is a position in which the center of front end and back end, in the conveyance direction, of cover sheet S2 which is placed on horizontal belts 98A and 98B, is stopped at a predetermined position located on the front side (in the conveyance direction) from the center of cover holding section 901. CPU (31) carries out conveyance of cover sheet S2 to adhesive receiving position B by controlling the operation of horizontal belt drive motor M7 which drives horizontal belts 98A and 98B.

When cover sheet S2 has been conveyed to adhesive receiving position B, adhesive coating section 60 is shifted from the home position to the adhesive discharging position.

As previously described, the adhesive discharging position is the position in which side surface portion 61D (to which discharge spout 61H is provided) of melt tank 61 (the bottom surface of which is kept horizontal) is positioned immediately above the center between the two sides, parallel to the conveyance direction, of cover sheet S2, having been conveyed to adhesive receiving position A. CPU (31) carries out the shifting of adhesive coating section 60 to the adhesive discharging position by controlling the operations of movable casing drive motor M3 which shifts adhesive coating section 60.

FIG. 18a is an explanatory diagram illustrating a positional relationship between melt tank 61, having been shifted to the adhesive discharging position, and cover sheet S2, having been shifted to adhesive receiving position B. Side surface portion 61D of melt tank 61, having been shifted to the adhesive discharging position, is positioned immediately above the center (center line L_{c}) between two sides, parallel to the conveyance direction, of cover sheet S2, having been conveyed to adhesive receiving position A. Therefore, as illustrated, center O of cover sheet S2, having been conveyed to adhesive receiving position B is positioned at the left-front side, in the figure, from the position immediately below discharge spout 61H of melt tank 61, having been shifted to the adhesive discharging position. It should be noted that, in this state, because the bottom surface of melt tank 61 is kept horizontal and discharge spout 61H is covered by lid member 65 (not illustrated in the figure), adhesive HMA inside melt tank 61 does not flow out through discharge spout 61H.

Referring to FIG. 17 again, CPU (31) energizes solenoid 73 (solenoid 730N) in step S510 subsequent to step S509.

As solenoid 73 is energized, melt tank 61 is turned, and the bottom surface results in an inclined state. As melt tank 61 is turned, discharge spout cover portion 654 is separated from side surface portion 61D of melt tank 61, whereby discharge spout 61H of melt tank 61 is opened, and adhesive HMA, having been stored in melt tank 61, flows out through discharge spout 61H, namely, adhesive HMA is discharged.

When CPU (31) initiates discharge of adhesive HMA from melt tank 61 by energizing solenoid 73, CPU (31) shifts cover sheet S2, which has been conveyed to adhesive receiving position B at a constant speed in the direction in which center O of cover sheet S2 approaches immediately below discharge spout 61H of melt tank 61, and passes immediately below discharge spout 61H. CPU (31) carries out this constant speed shifting of cover sheet S2 by controlling the operations of horizontal belt drive motor M7 which drives horizontal belts 98A and 98B.

FIG. 18b is a diagram illustrating a state in which adhesive HMA flows down from discharge spout 61H of melt tank 61, which has been turned, and is received by cover sheet S2. As illustrated, adhesive HMA, having been received by cover sheet S2, flows and spreads along the surface of cover sheet S2 toward the periphery of cover sheet S2 in a substantially concentric fashion around the flow-down position. Cover sheet S2 is shifted in the direction indicated by arrow p, illustrated in the figure, at a constant speed in which amount of movement is constant per unit time.

Adhesive HMA, having been discharged from melt tank 61, is received by cover sheet S2. Although adhesive HMA, having been received by cover sheet S2, flows along the surface of cover sheet S2 toward the periphery of cover sheet S2 in a substantially concentric fashion around the position (flow-down position) where the adhesive is received by cover sheet S2, adhesive HMA is cooled and solidifies upon exposure to air and contact with cover sheet S2, and adhered onto cover sheet S2.

FIG. 18c is a diagram illustrating a state of a time when a predetermined time has passed from the state illustrated in FIG. 18b. On the upper surface of cover sheet S2, which receives adhesive HMA while being shifted in the direction indicated by arrow p, adhesive HMA spreads and solidifies as time advances, and adhesive HMA stops flowing and is adhered onto cover sheet S2.

When CPU (31) initiates the discharge of adhesive HMA, having been stored in melt tank 61, CPU (31) then waits until completion of discharge of adhesive HMA from melt tank 61 in step S511.

CPU (31) determines, when operating in the adhesive discharging mode, that adhesive HMA has been discharged from melt tank 61 (step S511: YES) when detecting a drop in detected temperature by temperature sensor 64, and process flow advances to step S512.

In step S512, energization of solenoid 73 is turned off (solenoid 73 OFF). As energization of solenoid 73 is turned off, melt tank 61 is turned in the direction in which the bottom surface thereof becomes horizontal. As melt tank 61 turns, lid member 65 is turned by a biasing force of extension springs 66A and 66B, and discharge spout cover portion 654 of lid member 65 is pressed into contact with side surface portion 61D of melt tank 61, and covers discharge spout 61H of melt tank 61.

As the bottom surface of melt tank 61 turns to a horizontal position, CPU (31), in step S5121, terminates the constant speed shifting of cover sheet S2 by controlling the operations of horizontal belt drive motor M7.

Then, CPU (31), in step S513, shifts adhesive coating section 60, which is in the adhesive discharging position, to the home position by controlling the operations of movable casing drive motor M3.

After that, CPU (31) ejects cover sheet, onto which adhesive HMA has been adhered, to booklet ejecting section 100 in step S514, and displays screen 38G5 in step S515. Then, in step S516, when an operator or a person in charge of maintenance fixes the lid (lid member 65) to melt tank 61 by fixing screws 69A and 69B, and depresses YES button 38G5Y on screen 38G5 (step S516: YES), CPU (31) completes the series of operations in the adhesive discharging mode, and the process flow advances to step S6.

Cover sheet S2, which has been ejected to booklet ejecting section 100 in step S514 and adhesive HMA has been adhered thereon, can be removed easily and safely by the operator or the person in charge of maintenance.

Although the bookbinding apparatus, according to the second preferred embodiment of the present invention, having been described with reference to FIGS. 17, 18a, 18b, and 18c, is constituted so as to shift cover sheet at a constant speed during discharge of adhesive, it may be constituted so as to shift cover sheet S2 together with melt tank 61 during discharge of adhesive.

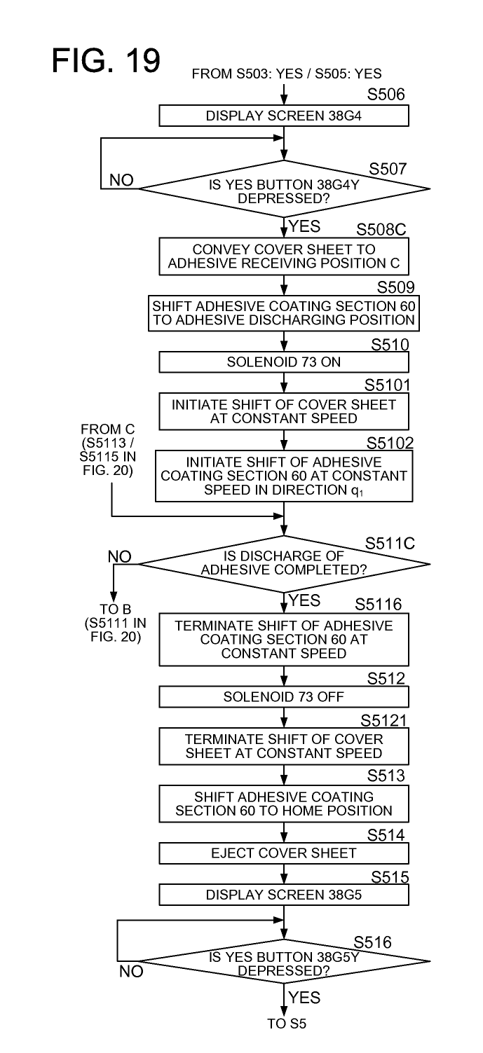

Hereinafter, a modification of the second preferred embodiment of the present invention will be described with reference to FIGS. 19, 20, 21a, 22b, and 22c.

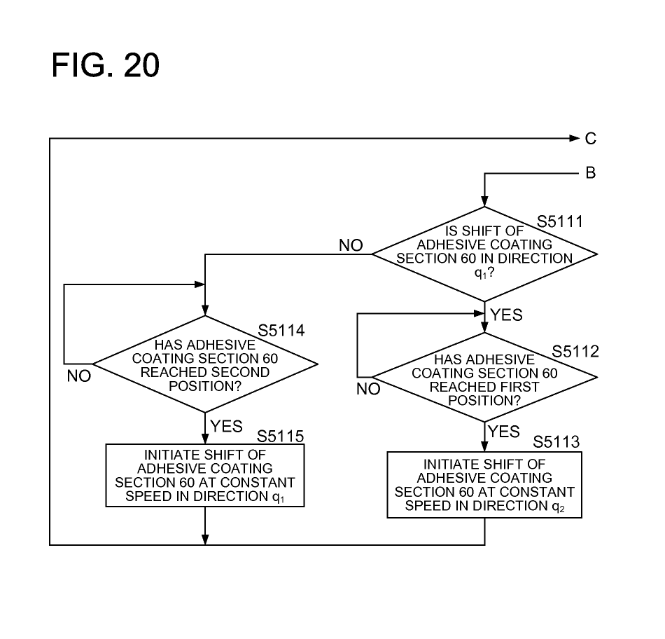

FIGS. 19 and 20 are each an explanatory flow chart illustrating operation of the modification of the second preferred embodiment according to the present invention, and is a flow chart of some parts of steps S506 to S516 are modified. FIG. 19 illustrates some parts of the flow chart of the modified steps, and FIG. 20 illustrates the remainder of the modified steps.

The operation of the modification of the bookbinding apparatus, according to the second preferred embodiment of the present invention, is a partially modified operation of discharge of adhesive of bookbinding apparatus B according to the second preferred embodiment of the present invention, previously described with reference to FIG. 17.

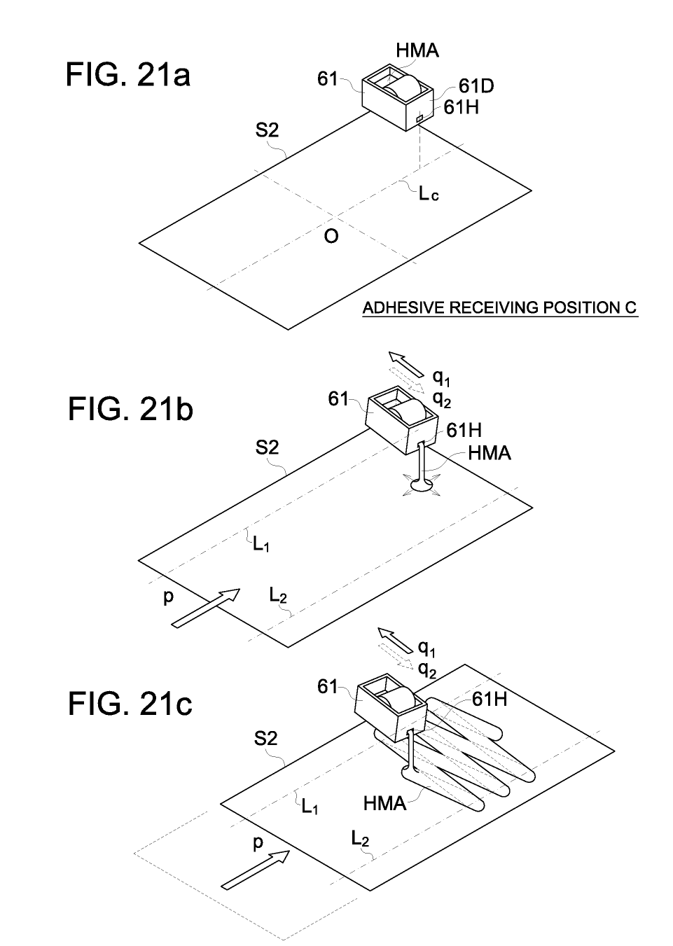

It should be noted that, because the steps in FIGS. 19 and 20, which have the identical step numbers of steps in FIG. 17, are the same as the steps in FIG. 17, there are cases in which explanations will be omitted. Also, FIGS. 21a, 21b, and 21c are each an explanatory diagram illustrating a positional relationship between melt tank 61 and a cover sheet when the modification of the second preferred embodiment operates in the adhesive discharging mode and discharges adhesive.

When YES button 38G1Y on screen 38G1, which has been displayed in step S4 in the previously described FIG. 13, is depressed by an operator or a person in charge of maintenance (step S4: YES), the process flow advances to step S5.

When advanced to step S5, the process flow advances to step S506, illustrated in FIG. 19, through steps S501 to S505 in FIG. 14.

Screen 38G4 is displayed in step S506, and CPU (31) waits until the operator or the person in charge of maintenance depresses YES button 38G4Y on screen 38G4.

When YES button 38G4Y is depressed (step S507: YES), the process flow advances to step S508C.

In step S508C, CPU (31) conveys cover sheet S2, having been stored in cover sheet storage section 80, to adhesive receiving position C by controlling the operations of cover sheet-conveyance shifting section 90.

Adhesive receiving position C is a position in which the center of front end and back end, in the conveyance direction, of cover sheet S2 which is placed on horizontal belts 98A and 98B, is stopped at a predetermined position located on the front side (in the conveyance direction) from the center of cover holding section 901. CPU (31) carries out the conveyance of cover sheet S2 to adhesive receiving position C by controlling the operations of horizontal belt drive motor M7 which drives horizontal belts 98A and 98B.

When cover sheet S2 has been conveyed to adhesive receiving position C, CPU (31), in step S509, shifts adhesive coating section 60 to the adhesive discharging position from the home position.

The adhesive discharging position is the position in which side surface portion 61D (to which discharge spout 61H is provided) of melt tank 61 (the bottom surface of which is kept horizontal) is positioned immediately above the center between the two sides, parallel to the conveyance direction, of cover sheet S2, having been conveyed to adhesive receiving position A. CPU (31) carries out the shifting of adhesive coating section 60 to the adhesive discharging position by controlling the operations of movable casing drive motor M3 which shifts adhesive coating section 60.

FIG. 21a is an explanatory diagram illustrating cover sheet S2, having been shifted to adhesive receiving position C, and melt tank 61, having been shifted to the adhesive discharging position.

Side surface portion 61D of melt tank 61, having been shifted to the adhesive discharging position, is positioned immediately above the center (center line L_{c}) between two sides, parallel to the conveyance direction, of cover sheet S2, having been conveyed to adhesive receiving position A. Therefore, as illustrated, center O of cover sheet S2, having been conveyed to adhesive receiving position C, is positioned at the left-front side, in the figure, from the position immediately below discharge spout 61H of melt tank 61, having been shifted to the adhesive discharging position. It should be noted that, in this state, because the bottom surface of melt tank 61 is kept horizontal and discharge spout 61H is covered by lid member 65 (not illustrated in the figure), adhesive HMA inside melt tank 61 does not flow out through discharge spout 61H.

Referring to FIG. 15 again, CPU (31) energizes solenoid 73 (solenoid 730N) in step S510 subsequent to step S509. As solenoid 73 is energized, melt tank 61 is turned, and the bottom surface becomes inclined. As melt tank 61 is turned, discharge spout cover portion 654 is separated from side surface portion 61D of melt tank 61 and discharge spout 61H of melt tank 61 is opened, and adhesive HMA, having been stored in melt tank 61, flows out through discharge spout 61H, namely, adhesive HMA is discharged.

When CPU (31) initiates discharge of adhesive HMA from melt tank 61 by energizing solenoid 73, CPU (31) shifts cover sheet S2, which has been conveyed to adhesive discharge position B, at a constant speed in the direction in which center O of cover sheet S2 approaches immediately below discharge spout 61H of melt tank 61, and passes immediately below discharge spout 61H. CPU (31) carries out this constant speed shifting of cover sheet S2 by controlling the operations of horizontal belt drive motor M7 which drives horizontal belts 98A and 98B.

In the following step S5102, CPU (31) shifts adhesive coating section 60, on which melt tank 61 is mounted, in the direction away from the home position at a constant speed. CPU (31) carries out this constant speed shifting of adhesive coating section 60 by controlling the operations of movable casing drive motor M3 which shifts adhesive coating section 60.

FIG. 21b is a diagram illustrating a state in which adhesive HMA flows down from discharge spout 61H of melt tank 61, and is received by cover sheet S2. Cover sheet S2 is shifted in the direction indicated by arrow p, illustrated in the figure, at a constant speed, in which amount of movement is constant per unit time, and melt tank 61, onto which adhesive coating section 60 is mounted, is shifted at a constant speed in the direction indicated by arrow q₁ (the direction away from the home position), illustrated in the figure.

L₁ and L₂, illustrated in the figure, are virtual straight lines indicating the range of shifting of adhesive coating section 60, which is to be shifted, and are set at a predetermined position between the two sides of cover sheet S2 in the longitudinal direction. The modification of the second preferred embodiment of the present invention is constituted such that, when discharge spout 61H of melt tank 61, which is shifted in the direction indicated arrow q₁ at a constant speed, has reached immediately above virtual straight line L₁ along the shifting of adhesive coating section 60, the shifting direction of adhesive coating section 60 is reversed and adhesive coating section 60 is shifted in the direction indicated by arrow q₂, and when discharge spout 61H of melt tank 61 of adhesive coating section 60, which is shifted in the direction indicated by arrow q₂ at a constant speed, has reached immediately above virtual straight line L₂, the shifting direction of adhesive coating section 60 again is reversed, and adhesive coating section 60 is shifted in the direction indicated by arrow q₁. CPU (31) controls this reciprocating shifting of melt tank 61 between virtual straight lines L₁ and L₂ by controlling the rotational direction and rotational angle of movable casing drive motor M3.

Hereinafter, a position in which discharge spout 61H of melt tank 61 of adhesive coating section 60 has reached immediately above virtual straight line L₁ is referred to as a first position, and a position in which discharge spout 61H has reached immediately above virtual straight line L₂ is referred to as a second position.

Adhesive HMA, having been discharged from melt tank 61, which is shifted at a constant speed in the direction indicated by arrow q₁, is received cover sheet S2. Adhesive HMA, having been received by cover sheet S2, flows along the surface of cover sheet S2 toward the periphery of cover sheet S2 in a substantially concentric fashion around the flow-down position, and cools and solidifies upon exposure to air and contact with cover sheet S2, and is adhered onto cover sheet S2.

Returning to FIG. 19, in step S511C subsequent to step S5102, determined is whether or not discharge of adhesive HMA has been completed. Whether or not discharge of adhesive HMA has been completed is determined by the detected temperature of temperature sensor 64. In cases in which discharge of adhesive HMA has not been completed (step S511C: NO), the process flow advances to step S5111 illustrated in FIG. 20.

In step S5111 in FIG. 20, CPU (31) confirms whether or not the shifting direction of adhesive coating section 60 is direction q₁, based on the rotational direction of movable casing drive motor M3, which shifts adhesive coating section 60, and if the shifting direction of adhesive coating section 60 is direction q₁ (step S5111: YES), the process flow advances to step S5112, and CPU (31) waits until adhesive coating section 60 has reached the first position. Whether or not adhesive coating section 60 has reached the first position is determined by judging whether or not the angle of rotation of movable casing drive motor M3 has reached a predetermined angle. When adhesive coating section 60 has reached the first position (step S5113: YES), the process flow returns to step S511C illustrated in FIG. 19. Also, in the case in which the shifting direction of adhesive coating section 60 is not the direction of q₁ (step S5111: NO), the process flow advances to S5114, and CPU (31) waits until adhesive coating section 60 has reached the second position. Whether or not adhesive coating section 60 has reached the second position is determined by judging whether or not the rotational angle of movable casing drive motor M3 has reached a predetermined angle. When adhesive coating section 60 has reached the second position (step S5114: YES), the process flow returns to step S511C illustrated in FIG. 19. In step S511C, whether or not discharge of adhesive HMA from melt tank 61 has been completed is confirmed, and if discharge of adhesive HMA has not been completed (step S511C: NO), the process of steps S5111 to S5115 is executed repeatedly until discharge of adhesive HMA has been completed. During the process of steps S5111 to S5115 being executed, discharge of adhesive HMA is carried out onto cover sheet 2 which is shifted in the direction indicated by arrow p.

FIG. 21c is a diagram illustrating a state of a time when a predetermined time has passed from the state of initiation of discharge of adhesive illustrated in FIG. 21b. On the upper surface of cover sheet S2, which receives adhesive HMA, while being conveyed in the direction indicated by arrow p, adhesive HMA, which has been discharged from melt tank 61 which shifts in the direction indicated by arrow q₁ or q₂, is spread in a zigzag pattern, and stops flowing as it solidifies as time advances, and is thereby adhered onto cover sheet S2. Also, because the shifting of melt tank 61 is within the range of virtual straight lines L₁ and L₂, it is possible to prevent adhesive HMA, which has been flowed onto the upper surface of cover sheet S2 and has been spread, from flowing down over the edge portions of cover sheet S2, by determining the positions of virtual straight lines L₁ and L₂ appropriately in advance.

In the case in which completion of discharge of adhesive HMA is confirmed in step S511C (step S511C: YES), the process flow advances to step S5116, and shifting of adhesive coating section 60 is terminated, and in the following step S512, the energization of solenoid 73 is turned off (solenoid 730M, and the shifting of cover sheet S2 at constant speed is terminated in step S5121.

Then, in step S513, adhesive coating section 60 is shifted to the home position by controlling the operations of movable casing drive motor M3.

After that, in step S514, cover sheet S2, onto which adhesive HMA has been adhered, is ejected to booklet ejecting section 100, and screen 38G5 is displayed in step S515. Then, in step S516, when an operator or a person in charge of maintenance fixes the lid (lid member 65) to melt tank 61 and depresses YES button 38G5Y on screen 38G5 (step S516: YES), the series of operations in the adhesive discharging mode is completed, and the process flow advances to step S6.

Cover sheet S2, which has been ejected to booklet ejecting section 100 in step S514 and adhesive HMA has been adhered thereon, can be easily and safely removed by the operator or the person in charge of maintenance.

In such a manner, bookbinding apparatus B according to the second preferred embodiment of the present invention, is capable of not only removing deteriorated adhesive from melt tank 61 efficiently, and easily and safely, but also discharging more amount of adhesive from melt tank 61 by shifting the cover sheet which receives adhesive flowing down thereon, or by varying opposing position therebetween by shifting the melt tank together with the cover sheet. It should be noted that a sheet which receives adhesive is not limited to a cover sheet, and it may also a sheet other than a cover sheet.

Although the preferred embodiment of the present invention have been fully described by way of examples with reference to the accompanying drawings, it is to be noted that various changes and modifications will be apparent to those skilled in the art. Therefore, unless such changes and modifications depart from the scope of the present invention, they are to be construed as being included therein.

1. A bookbinding apparatus comprising:
a stacking section for stacking sheets to form a bundle of sheets;
a sheet-conveyance shifting section for conveying a sheet, or a cover sheet to become a cover of a booklet to a predetermined position;
a melt tank for storing a hot-melt adhesive; and
a bookbinding control section configured to execute a bookbinding mode in which a booklet is formed by coating an adhesive inside said melt tank to an edge surface of the bundle of sheets and adhering the cover sheet to the edge surface, onto which the adhesive has been coated, of the bundle of sheets, and an adhesive discharging mode in which the adhesive inside said melt tank is discharged outside said melt tank.

2. The bookbinding apparatus described in claim 1, wherein, when operating in said adhesive discharging mode, said bookbinding control section is configured to discharge the adhesive, having been stored in said melt tank, onto a sheet, and eject the sheet, which has received thereon the discharged adhesive from said melt tank, outside the apparatus.

3. The bookbinding apparatus described in claim 1, wherein said melt tank comprises a discharge spout to discharge the stored adhesive outside said melt tank.

4. The bookbinding apparatus described in claim 3, further comprising a lid member to open or close said discharge spout, wherein, when said bookbinding apparatus operates in said bookbinding mode, said lid member closes said discharge spout, and when said bookbinding apparatus operates in said adhesive discharging mode, said lid member opens said discharge spout.

5. The bookbinding apparatus described in claim 1, further comprising an inclining member to incline said melt tank, wherein, when said bookbinding apparatus operates in said adhesive discharging mode, said bookbinding control section is configured to control said inclining member to incline said melt tank.

6. The bookbinding apparatus described in claim 1, wherein, while discharging the adhesive from said melt tank by operating in said adhesive discharging mode, said bookbinding control section is configured to control an operation of said sheet-conveyance shifting section so as to vary an opposing position between said melt tank and a sheet which receives thereon the adhesive to be discharged from said melt tank.

7. The bookbinding apparatus described in claim 6, further comprising a melt tank shifting section to shift said melt tank along the bundle of sheets, wherein said bookbinding control section is configured to control both said sheet-conveyance shifting section and said melt, tank shifting section so as to vary the opposing position between said melt tank and a sheet which receives thereon the adhesive to be discharged from said melt tank.

8. The bookbinding apparatus described in claim 4, further comprising a fail-safe device to prevent said lid member from shifting from a state in which said discharge spout is closed to a state in which said discharge spout is opened, wherein an operation in said adhesive discharging mode is not performed when said fail-safe device functions, and the operation in said adhesive discharging mode can be performed when a function of said fail-safe device is released.

9. The bookbinding apparatus described in claim 1, wherein said sheet-conveyance shifting section is a cover sheet-conveyance shifting section to convey a cover sheet to become a cover of a booklet.

10. A bookbinding system comprising:
an image forming apparatus for forming an image on a sheet; and
the bookbinding apparatus described in claim 1, which generates a booklet by receiving a sheet from said image forming apparatus.

11. A bookbinding system comprising:
an image forming apparatus for forming an image on a sheet; and
the binding apparatus described in claim 2, which generates a booklet by receiving a sheet from said image forming apparatus.

12. A bookbinding system comprising:
an image forming apparatus for forming an image on a sheet; and
the bookbinding apparatus described in claim which generates a booklet by receiving a sheet from said image forming apparatus.

13. A bookbinding system comprising:
an image forming apparatus for forming an image on a sheet; and
the binding apparatus described in claim 4, which generates a booklet by receiving a sheet from said image forming apparatus.

14. A bookbinding system comprising:
an image forming apparatus for forming an image on a sheet; and
the binding apparatus described in claim 5, which generates a booklet by receiving a sheet from said image forming apparatus.

15. A bookbinding system comprising:
an image forming apparatus for forming an image on a sheet; and
the binding apparatus described in claim 6, which generates a booklet by receiving a sheet from said image forming apparatus.

16. A bookbinding system comprising:
an image forming apparatus for forming an image on a sheet; and
the binding apparatus described in claim 7, which generates a booklet by receiving a sheet from said image forming apparatus.

17. A bookbinding system comprising:
an image forming apparatus for forming an image on a sheet; and
the binding apparatus described in claim 8, which generates a booklet by receiving a sheet from said image forming apparatus.

18. A bookbinding system comprising:
an image forming apparatus for forming an image on a sheet; and
the binding apparatus described in claim 9, which generates a booklet by receiving a sheet from said image forming apparatus.
